(19) United States
(12) Patent Application Publication
(10) Pub. No.: US 2003/0212805 A1
(43) Pub. Date: Nov. 13, 2003

(54) Profile information acquisition program and apparatus

(76) Inventors: Kinichi Motosaka, Katano-shi (JP); Masahiro Oashi, Kyotanabe-shi (JP); Norio Samada, Kobe-shi (JP)

Correspondence Address: SNELL & WILMER LLP, 1920 MAIN STREET, SUITE 1200, IRVINE, CA, 92614-7230, US

(21) Appl. No.: 10/368,193

(22) Filed: Feb. 18, 2003

(30) Foreign Application Priority Data
Feb. 18, 2002 (JP) JP2002-040726

(51) Int. Cl. G06F 15/16

(52) U.S. Cl. 709/228

(57) ABSTRACT

Pieces of profile information are linked directly or indirectly and recorded into a storage area named a profile information storage area in an order in which software programs, which have generated the pieces of profile information, started.

### BACKGROUND OF THE INVENTION

(1) Field of the Invention

The present invention relates to a technique for obtaining profile information that is generated when software programs in layers of a software system are processed.

(2) Description of the Related Art

In recent years, as digitization has progressed, household electric appliances have had a multiplicity of functions deleting and combining old functions. On the other hand, the size of the software programs embedded in the household electric appliances has increased, and the operation has become complicated. From the viewpoint of reducing development cost or period, it is more general to use a software program that has been developed for a device than to develop a software program from scratch. It is possible to execute in the same household electric appliance a plurality of software programs that have been developed for different devices, by one of the following two methods.

In the first method, a plurality of operating systems are operated on a micro kernel, and software programs are executed on the operating systems.

In the second method, an operating system is emulated on a monolithic kernel, and software programs are executed on the emulated operating system.

In either case, software programs to be embedded in household electric appliances are executed in a software system that has a hierarchical structure composed of layers of operating systems.

To develop a software program, which is increasing in size and becoming complicated as described above, in a short period in a software system that has a hierarchical structure, debugging or tuning is more important than in the past. A profiler is a program that is very effective in performing the debugging or tuning for a software program.

It should be noted here that the profiler is a program for acquiring data (hereinafter referred to as profile information) generated when each software program is executed in a general hardware system such as a computer or a household electric appliance.

It should be noted here that the profile information shows a program execution history and includes data concerning each module, function, method, or system call, the data being, for example: (a) an execution time; (b) the number of executions of statements (steps); (c) the number of branches for each of true and false at each branch; (d) a variable value; and (e) memory use state.

However, such a software system having a hierarchical structure has a problem that pieces of profile information may not be recorded in the order of processes.

The problem occurs when, for example, the profiler acquires and records the profile information of a software program in a lower layer (hereinafter referred to merely as a lower layer) prior to acquiring and recording the profile information of a software program in an upper layer (hereinafter referred to merely as an upper layer) when the control moves to the lower layer for execution of the upper layer.

Here, if the profile information of the upper layer is acquired and recorded before the control moves to the lower layer, the profile information may not be recorded correctly due to dependency of variables and functions.

Also, there is another problem that pieces of profile information may be recorded in an order that is different from an actual order in which the pieces of profile information are acquired, depending on the positions (for example, positions in a source code) where the pieces of profile information are acquired.

If pieces of profile information are not recorded in the order of executions of software programs, it is difficult to trace the executions of software programs.

### SUMMARY OF THE INVENTION

The object of the present invention is therefore to provide a profile information acquisition program or apparatus that facilitates tracing executions of software programs in a software system having a hierarchical structure including layers of software programs.

(1) The above object is fulfilled by a profile information acquisition apparatus for acquiring profile information generated in a hardware system under control of a software system having a hierarchical structure composed of layers of software programs including a first program and a second program, the second program calling and executing the first program, the profile information acquisition apparatus comprising: a storage area allocating unit operable to allocate a hardware system space to a profile information storage area for recording the profile information; a second-profile-information acquiring unit operable to, when profile information generated by execution of the second program is regarded as second profile information, allocate, during a time period ranging from a start of the execution of the second program to a start of execution of the first program, a space of the profile information storage area to a second storage area for recording the second profile information, acquire the second profile information, and record the acquired second profile information into the second storage area; and a first-profile-information acquiring unit operable to, when profile information generated by execution of the first program is regarded as first profile information, acquire, during a time period ranging from the start of the execution of the first program to an end of the execution of the first program, the first profile information, and record the acquired first profile information into a first storage area that follows the second storage area.

With the above-described construction, the profile information acquisition apparatus acquires pieces of profile information that are generated when software programs are executed, and records the acquired pieces of profile information into the profile information storage area allocated in the hardware system by arranging them in an order in which the software programs are executed. Such a construction provides an effect of facilitating tracing executions of the software programs since it enables one to directly trace the address spaces in which the pieces of profile information are recorded in an arrangement that does not depend on the positions (for example, positions in a source code) at which the pieces of profile information are acquired. This construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(2) In the above profile information acquisition apparatus of (1), when information indicating a lowest address of a storage area in which no profile information is recorded and that is not reserved for recording profile information is regarded as end position information, and when information indicating a lowest address of a storage area that is reserved for recording profile information is regarded as reserved position information, the storage area allocating unit may allocate hardware system spaces to (i) an end position information storage area for recording the end position information and (ii) a reserved position information storage area for recording the reserved position information by a First-In-Last-Out method, and when a pointer, which indicates an address in the profile information storage area at which the profile information starts to be recorded, is regarded as a recording start pointer, the second-profile-information acquiring unit includes: a reserving unit operable to, when an address, which is indicated by the recording start pointer when the second storage area is allocated, is regarded as a second start address, and reserved position information indicating the second start address is regarded as second reserved position information, record the second reserved position information into the reserved position information storage area, and shift the recording start pointer upward from the second start address by a size of the second profile information; and a recording unit operable to, when an address, which is indicated by the recording start pointer when the second profile information is recorded, is regarded as a second end address, and end position information indicating the second end address is regarded as second end position information, record the second end position information into the end position information storage area, read the second reserved position information from the reserved position information storage area, move the recording start pointer to the second start address indicated by the second reserved position information, record the second profile information starting at the second start address toward upper addresses, read the second end position information from the end position information storage area, and move the recording start pointer to the second end address indicated by the second end position information.

The above-described construction, in which a storage area for recording a piece of profile information to be acquired is reserved in advance, has an effect that the arrangement of the acquired pieces of profile information in the profile information storage area is ensured regardless of the positions at which the pieces of profile information are acquired. This construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(3) In the above profile information acquisition apparatus of (2), the first-profile-information acquiring unit may allocate a space of the profile information storage area to the first storage area during a time period ranging from the start of the execution of the first program to the acquisition of the first profile information.

The above-described construction, in which not only a caller of a software program but the software program itself to be called reserves a storage area for recording profile information, provides an effect that the arrangement of the acquired pieces of profile information in the profile information storage area is ensured when a system composed of a plurality of (three or more) layers operates on the hardware system. This construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(4) In the above profile information acquisition apparatus of (3), the first profile information and the second profile information may have either a same fixed length or different fixed lengths.

The above-described construction, in which pieces of profile information can be traced by the fixed size thereof, provides an effect of facilitating tracing executions of software programs. This construction also provides an effect of recording profile information that has a different size for each layer.

(5) In the above profile information acquisition apparatus of (4), the reserving unit, when shifting the recording start pointer upward from the second start address, may write either (i) information indicating a reserved state or (ii) information indicating a layer to which the second program belongs, into the second storage area for the size of the second profile information.

The above-described construction provides an effect that if a process stops due to an unauthorized process or the like while profile information is recorded, it becomes information that indicates a problematic portion.

(6) The above object is also fulfilled by a profile information acquisition apparatus for acquiring profile information generated in a hardware system under control of a software system having a hierarchical structure composed of layers of software programs including a first program and a second program, the second program calling and executing the first program, the profile information acquisition apparatus comprising: a storage area allocating unit operable to, when information indicating a lowest address of a storage area in which profile information is recorded is regarded as linkage position information, allocate a hardware system space to a linkage position information storage area for recording the linkage position information; a second-profile-information acquiring unit operable to, when profile information generated by execution of the second program is regarded as second profile information, and when linkage position information indicating a lowest address of a storage area in which the second profile information is recorded is regarded as second linkage position information, allocate, during a time period ranging from a start of the execution of the second program to a start of execution of the first program, a space of the linkage position information storage area to a second storage area for recording the second linkage position information, acquire the second profile information, and record the second linkage position information into the second storage area; and a first-profile-information acquiring unit operable to, when profile information generated by execution of the first program is regarded as first profile information, and when linkage position information indicating a lowest address of a storage area in which the first profile information is recorded is regarded as first linkage position information, acquire, during a time period ranging from the start of the execution of the first program to an end of the execution of the first program, the first profile information, and record the first linkage position information into a first storage area that follows the second storage area.

With the above-described construction, the profile information acquisition apparatus acquires pieces of profile information that are generated when software programs are executed, and records pieces of linkage position information, which indicate the lowest addresses of storage areas in which acquired pieces of profile information are recorded, into the linkage position information storage area allocated in the hardware system by arranging them in an order in which the software programs are executed. Such a construction provides an effect of facilitating tracing executions of the software programs since it enables one to indirectly trace, via the linkage position information, the address spaces in which the pieces of linkage position information are recorded in an arrangement that does not depend on the positions (for example, positions in a source code) at which the pieces of profile information are acquired. The construction also provides an effect of increasing development flexibility since the arrangement of the pieces of linkage position information in the linkage position information storage area is ensured regardless of the positions at which the pieces of profile information are acquired, even if the pieces of profile information are acquired at positions selected from a plurality of positions.

(7) In the above profile information acquisition apparatus of (6), when information indicating a lowest address of a storage area in which no linkage position information is recorded and that is not reserved for recording linkage position information is regarded as end position information, and when information indicating a lowest address of a storage area that is reserved for recording linkage position information is regarded as reserved position information, the storage area allocating unit may allocate hardware system spaces to (i) an end position information storage area for recording the end position information and (ii) a reserved position information storage area for recording the reserved position information by a First-In-Last-Out method and when a pointer, which indicates an address in the linkage position information storage area at which the linkage position information starts to be recorded, is regarded as a recording start pointer, the second-profile-information acquiring unit includes: a reserving unit operable to, when an address, which is indicated by the recording start pointer when the second storage area is allocated, is regarded as a second start address, and reserved position information indicating the second start address is regarded as second reserved position information, record the second reserved position information into the reserved position information storage area, and shift the recording start pointer upward from the second start address by a size of the second linkage position information; and a recording unit operable to, when an address, which is indicated by the recording start pointer when the second linkage position information is recorded, is regarded as a second end address, and end position information indicating the second end address is regarded as second end position information,

record the second end position information into the end position information storage area, read the second reserved position information from the reserved position information storage area, move the recording start pointer to the second start address indicated by the second reserved position information, record the second linkage position information starting at the second start address toward upper addresses, read the second end position information from the end position information storage area, and move the recording start pointer to the second end address indicated by the second end position information.

The above-described construction, in which a storage area for recording a piece of linkage position information corresponding to a piece of profile information to be acquired is reserved in advance, has an effect that the arrangement of the pieces of linkage position information in the linkage position information storage area is ensured regardless of the positions at which the pieces of profile information are acquired. This construction also provides an effect of increasing development flexibility since the arrangement of the pieces of linkage position information in the linkage position information storage area is ensured regardless of the positions at which the pieces of profile information are acquired, even if the pieces of profile information are acquired at positions selected from a plurality of positions.

(8) In the above profile information acquisition apparatus of (7), the first-profile-information acquiring unit may allocate a space of the linkage position information storage area to the first storage area during a time period ranging from the start of the execution of the first program to the acquisition of the first linkage position information.

The above-described construction, in which not only a caller of a software program but the software program itself to be called reserves a storage area for recording linkage position information, provides an effect that the arrangement of the pieces of linkage position information in the linkage position information storage area is ensured when a system composed of a plurality of (three or more) layers operates on the hardware system. This construction also provides an effect of increasing development flexibility since the arrangement of the pieces of linkage position information in the linkage position information storage area is ensured regardless of the positions at which the pieces of profile information are acquired, even if the pieces of profile information are acquired at positions selected from a plurality of positions.

(9) In the above profile information acquisition apparatus of (8), the first linkage position information and the second linkage position information may have either a same fixed length or different fixed lengths.

The above-described construction, in which pieces of linkage position information can be traced by the fixed size thereof, provides an effect of facilitating tracing executions of software programs. This construction also provides an effect of recording linkage position information that has a different size for each layer.

(10) In the above profile information acquisition apparatus of (9), the reserving unit, when shifting the recording start pointer upward from the second start address, writes either (i) information indicating a reserved state or (ii) information indicating a layer to which the second program belongs, into the second storage area for the size of the second linkage position information.

The above-described construction provides an effect that if a process stops due to an unauthorized process or the like while linkage position information is recorded, it becomes information that indicates a problematic portion.

(11) The above object is also fulfilled by a profile information acquisition apparatus for acquiring profile information generated in a hardware system under control of a software system having a hierarchical structure composed of layers of software programs including a first program and a second program, the second program calling and executing the first program, the profile information acquisition apparatus comprising: a storage area allocating unit operable to allocate a space of an external storage apparatus, which is connected via a network to the hardware system, to a profile information storage area for recording the profile information; a second-profile-information acquiring unit operable to, when profile information generated by execution of the second program is regarded as second profile information, allocate, during a time period ranging from a start of the execution of the second program to a start of execution of the first program, a space of the profile information storage area to a second storage area for recording the second profile information, acquire the second profile information, and record the acquired second profile information into the second storage area; and a first-profile-information acquiring unit operable to, when profile information generated by execution of the first program is regarded as first profile information, acquire, during a time period ranging from the start of the execution of the first program to an end of the execution of the first program, the first profile information, and record the acquired first profile information into a first storage area that follows the second storage area.

With the above-described construction, the profile information acquisition apparatus acquires pieces of profile information that are generated when software programs are executed, and records the acquired pieces of profile information into the profile information storage area allocated in the hardware system by arranging them in an order in which the software programs are executed. Such a construction provides an effect of facilitating tracing executions of the software programs since it enables one to directly trace the address spaces in which the pieces of profile information are recorded in an arrangement that does not depend on the positions (for example, positions in a source code) at which the pieces of profile information are acquired. This construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(12) The above object is also fulfilled by a profile information acquisition apparatus for acquiring profile information generated in a hardware system under control of a software system having a hierarchical structure composed of layers of software programs including a first program and a second program, the second program calling and executing the first program, the profile information acquisition apparatus comprising: a storage area allocating unit operable to, when information indicating a lowest address of a storage area in which profile information is recorded is regarded as linkage position information, allocate a space of an external storage apparatus, which is connected via a network to the hardware system, to a linkage position information storage area for recording the linkage position information; a second-profile-information acquiring unit operable to, when profile information generated by execution of the second program is regarded as second profile information, and when linkage position information indicating a lowest address of a storage area in which the second profile information is recorded is regarded as second linkage position information, allocate, during a time period ranging from a start of the execution of the second program to a start of execution of the first program, a space of the linkage position information storage area to a second storage area for recording the second linkage position information, acquire the second profile information, and record the second linkage position information into the second storage area; and a first-profile-information acquiring unit operable to, when profile information generated by execution of the first program is regarded as first profile information, and when linkage position information indicating a lowest address of a storage area in which the first profile information is recorded is regarded as first linkage position information, acquire, during a time period ranging from the start of the execution of the first program to an end of the execution of the first program, the first profile information, and record the first linkage position information into a first storage area that follows the second storage area.

With the above-described construction, the profile information acquisition apparatus acquires pieces of profile information that are generated when software programs are executed, and records pieces of linkage position information, which indicate the lowest addresses of storage areas in which acquired pieces of profile information are recorded, into the linkage position information storage area allocated in the hardware system by arranging them in an order in which the software programs are executed. Such a construction provides an effect of facilitating tracing executions of the software programs since it enables one to indirectly trace, via the linkage position information, the address spaces in which the pieces of linkage position information are recorded in an arrangement that does not depend on the positions (for example, positions in a source code) at which the pieces of profile information are acquired. The construction also provides an effect of increasing development flexibility since the arrangement of the pieces of linkage position information in the linkage position information storage area is ensured regardless of the positions at which the pieces of profile information are acquired, even if the pieces of profile information are acquired at positions selected from a plurality of positions.

(13) The above object is also fulfilled by a profile information acquisition system composed of a profile information acquisition agent apparatus and a profile information acquisition management apparatus, the profile information acquisition agent apparatus acquiring profile information generated in a hardware system under control of a software system having a hierarchical structure composed of layers of software programs including a first program and a second program, the second program calling and executing the first program, the profile information acquisition management apparatus managing the profile information, the profile information acquisition agent apparatus comprising: a second-profile-information acquiring unit operable to, when profile information generated by execution of the second program is regarded as second profile information, instruct, during a time period ranging from a start of the execution of the second program to a start of execution of the first program, to create a second reserve message that indicates that the second profile information is to be transmitted later, acquire the second profile information, and instruct to create a second record message containing the second profile information; a first-profile-information acquiring unit operable to, when profile information generated by execution of the first program is regarded as first profile information, acquire, during a time period ranging from the start of the execution of the first program to an end of the execution of the first program, the first profile information, and instruct to create a first record message containing the first profile information; a message creation unit operable to create a message ID that is identification information created uniquely for each message so as to increase in time series, create the second reserve message together with a message containing (i) a message ID of the second reserve message and (ii) a size of the second profile information, temporarily store the message ID of the second reserve message as position information, create the first record message together with a message containing (i) a message ID of the first record message and (ii) the first profile information, and create the second record message together with a message containing (i) a message ID of the second record message and (ii) the second profile information; and a message transmission unit operable to transmit messages to the profile information acquisition management apparatus in an order in which the messages are created, the profile information acquisition management apparatus comprising: a message reception unit operable to receive a message from the profile information acquisition agent apparatus; a message response unit operable to analyze the received message, if the received message is found to be the second reserve message, create dummy data in accordance with the second reserve message, instruct to record the dummy data into a profile information database instead of the second reserve message, and instruct to register the message ID contained in the second reserve message with a position information database as position information, and if the received message is found to be the second record message, instruct to replace the dummy data recorded in the profile information database with the second profile information contained in the second record message; a position information management unit operable to create an entry ID that is identification information created uniquely for each piece of point information and increases in time series, and register the point information with the position information database in a manner in which the point information is correlated with the entry ID; and a profile information management unit operable to create a record ID that is identification information created uniquely for each piece of profile information and increases in time series, and record the dummy data into the profile information database in a manner in which the dummy data is correlated with the record ID, and replace the dummy data, which is correlated with the record ID, with the second profile information.

With the above-described construction, the profile information acquisition agent apparatus of the profile information acquisition system acquires pieces of profile information that are generated when software programs are executed, and transmits the acquired pieces of profile information to the profile information acquisition management apparatus. The profile information acquisition management apparatus manages the pieces of profile information by arranging them in an order in which the software programs are executed. Such a construction provides an effect of facilitating tracing executions of the software programs since the arrangement of the pieces of profile information managed by the profile information acquisition management apparatus is ensured, not depending on the positions (for example, positions in a source code) at which the pieces of profile information are acquired. The construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(14) The above object is also fulfilled by a profile information acquisition agent apparatus for acquiring profile information generated in a hardware system under control of a software system having a hierarchical structure composed of layers of software programs including a first program and a second program, the second program calling and executing the first program, the profile information acquisition agent apparatus comprising: a second-profile-information acquiring unit operable to, when profile information generated by execution of the second program is regarded as second profile information, instruct, during a time period ranging from a start of the execution of the second program to a start of execution of the first program, to create a second reserve message that indicates that the second profile information is to be transmitted later, acquire the second profile information, and instruct to create a second record message containing the second profile information; a first-profile-information acquiring unit operable to, when profile information generated by execution of the first program is regarded as first profile information, acquire, during a time period ranging from the start of the execution of the first program to an end of the execution of the first program, the first profile information, and instruct to create a first record message containing the first profile information; a message creation unit operable to create a message ID that is identification information created uniquely for each message so as to increase in time series, create the second reserve message together with a message containing (i) a message ID of the second reserve message and (ii) a size of the second profile information, temporarily store the message ID of the second reserve message as position information, create the first record message together with a message containing (i) a message ID of the first record message and (ii) the first profile information, and create the second record message together with a message containing (i) a message ID of the second record message and (ii) the second profile information; and a message transmission unit operable to transmit messages to a profile information acquisition management apparatus for managing the profile information, in an order in which the messages are created.

With the above-described construction, the profile information acquisition agent apparatus acquires pieces of profile information that are generated when software programs are executed, and transmits the acquired pieces of profile information to the profile information acquisition management apparatus. The profile information acquisition management apparatus manages the pieces of profile information by arranging them in an order in which the software programs are executed. Such a construction provides an effect of facilitating tracing executions of the software programs since the arrangement of the pieces of profile information managed by the profile information acquisition management apparatus is ensured, not depending on the positions (for example, positions in a source code) at which the pieces of profile information are acquired. The construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(15) The above object is also fulfilled by a profile information acquisition management apparatus for managing profile information generated in a hardware system under control of a software system having a hierarchical structure composed of layers of software programs including a first program and a second program, the second program calling and executing the first program, the profile information acquisition management apparatus comprising: a message reception unit operable to receive a message from a profile information acquisition agent apparatus that acquires the profile information; a message response unit operable to, when profile information generated by execution of the second program is regarded as second profile information, when a message indicating that the second profile information is to be transmitted later is regarded as a second reserve message, and when a message containing the second profile information is regarded as a second record message, analyze the received message, if the received message is found to be the second reserve message, create dummy data in accordance with the second reserve message, instruct to record the dummy data into a profile information database instead of the second reserve message, and instruct to register the message ID contained in the second reserve message with a position information database as position information, and if the received message is found to be the second record message, instruct to replace the dummy data recorded in the profile information database with the second profile information contained in the second record message; a position information management unit operable to create an entry ID that is identification information created uniquely for each piece of point information and increases in time series, and register the point information with the position information database in a manner in which the point information is correlated with the entry ID; and a profile information management unit operable to create a record ID that is identification information created uniquely for each piece of profile information and increases in time series, and record the dummy data into the profile information database in a manner in which the dummy data is correlated with the record ID, and replace the dummy data, which is correlated with the record ID, with the second profile information.

With the above-described construction, the profile information acquisition agent apparatus acquires pieces of profile information that are generated when software programs are executed, and transmits the acquired pieces of profile information to the profile information acquisition management apparatus. The profile information acquisition management apparatus manages the pieces of profile information by arranging them in an order in which the software programs are executed. Such a construction provides an effect of facilitating tracing executions of the software programs since the arrangement of the pieces of profile information managed by the profile information acquisition management apparatus is ensured, not depending on the positions (for example, positions in a source code) at which the pieces of profile information are acquired. The construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(16) The above object is also fulfilled by a profile information acquisition program for acquiring profile information generated in a hardware system under control of a software system having a hierarchical structure composed of layers of software programs including a first program and a second program, the second program calling and executing the first program, the profile information acquisition program comprising and causing the hardware system and the software system to execute the following steps cooperatively:

a storage area allocating step for allocating a hardware system space to a profile information storage area for recording the profile information; a second-profile-information acquiring step for, when profile information generated by execution of the second program is regarded as second profile information, allocating, during a time period ranging from a start of the execution of the second program to a start of execution of the first program, a space of the profile information storage area to a second storage area for recording the second profile information, acquiring the second profile information, and recording the acquired second profile information into the second storage area; and a first-profile-information acquiring step for, when profile information generated by execution of the first program is regarded as first profile information, acquiring, during a time period ranging from the start of the execution of the first program to an end of the execution of the first program, the first profile information, and recording the acquired first profile information into a first storage area that follows the second storage area.

With the above-described construction, a general hardware system such as a computer receives the profile information acquisition program via a computer-readable recording medium or a network connected to the computer, and executes the received profile information acquisition program. The hardware system then acquires pieces of profile information that are generated when software programs are executed, and records the acquired pieces of profile information into the profile information storage area allocated in the hardware system by arranging them in an order in which the software programs are executed. Such a construction provides an effect of facilitating tracing executions of the software programs since it enables one to directly trace the address spaces in which the pieces of profile information are recorded in an arrangement that does not depend on the positions (for example, positions in a source code) at which the pieces of profile information are acquired. This construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(17) In the above profile information acquisition program of (16), when information indicating a lowest address of a storage area in which no profile information is recorded and that is not reserved for recording profile information is regarded as end position information, and when information indicating a lowest address of a storage area that is reserved for recording profile information is regarded as reserved position information, the storage area allocating step may allocate hardware system spaces to (i) an end position information storage area for recording the end position information and (ii) a reserved position information storage area for recording the reserved position information by a First-In-Last-Out method, and when a pointer, which indicates an address in the profile information storage area at which the profile information starts to be recorded, is regarded as a recording start pointer, the second-profile-information acquiring step includes: a reserving substep for, when an address, which is indicated by the recording start pointer when the second storage area is allocated, is regarded as a second start address, and reserved position information indicating the second start address is regarded as second reserved position information, recording the second reserved position information into the reserved position information storage area, and shifting the recording start pointer upward from the second start address by a size of the second profile information; and a recording substep for, when an address, which is indicated by the recording start pointer when the second profile information is recorded, is regarded as a second end address, and end position information indicating the second end address is regarded as second end position information, recording the second end position information into the end position information storage area, reading the second reserved position information from the reserved position information storage area, moving the recording start pointer to the second start address indicated by the second reserved position information, recording the second profile information starting at the second start address toward upper addresses, reading the second end position information from the end position information storage area, and moving the recording start pointer to the second end address indicated by the second end position information.

The above-described construction, in which a storage area for recording a piece of profile information to be acquired is reserved in advance, has an effect that the arrangement of the acquired pieces of profile information in the profile information storage area is ensured regardless of the positions at which the pieces of profile information are acquired. This construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(18) In the above profile information acquisition program of (17), the first-profile-information acquiring step may allocate a space of the profile information storage area to the first storage area during a time period ranging from the start of the execution of the first program to the acquisition of the first profile information.

The above-described construction, in which not only a caller of a software program but the software program itself to be called reserves a storage area for recording profile information, provides an effect that the arrangement of the acquired pieces of profile information in the profile information storage area is ensured when a system composed of a plurality of (three or more) layers operates on the hardware system. This construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(19) In the above profile information acquisition program of (18), the first profile information and the second profile information may have either a same fixed length or different fixed lengths.

The above-described construction, in which pieces of profile information can be traced by the fixed size thereof, provides an effect of facilitating tracing executions of software programs. This construction also provides an effect of recording profile information that has a different size for each layer.

(20) In the above profile information acquisition program of (19), the reserving substep, when shifting the recording start pointer upward from the second start address, may write either (i) information indicating a reserved state or (ii) information indicating a layer to which the second program belongs, into the second storage area for the size of the second profile information.

The above-described construction provides an effect that if a process stops due to an unauthorized process or the like while profile information is recorded, it becomes information that indicates a problematic portion.

(21) The above object is also fulfilled by a profile information acquisition program for acquiring profile information generated in a hardware system under control of a software system having a hierarchical structure composed of layers of software programs including a first program and a second program, the second program calling and executing the first program, the profile information acquisition program comprising and causing the hardware system and the software system to execute the following steps cooperatively: a storage area allocating step for, when information indicating a lowest address of a storage area in which profile information is recorded is regarded as linkage position information, allocating a hardware system space to a linkage position information storage area for recording the linkage position information; a second-profile-information acquiring step for, when profile information generated by execution of the second program is regarded as second profile information, and when linkage position information indicating a lowest address of a storage area in which the second profile information is recorded is regarded as second linkage position information, allocating, during a time period ranging from a start of the execution of the second program to a start of execution of the first program, a space of the linkage position information storage area to a second storage area for recording the second linkage position information, acquiring the second profile information, and recording the acquired linkage position information into the second storage area; and a first-profile-information acquiring step for, when profile information generated by execution of the first program is regarded as first profile information, and when linkage position information indicating a lowest address of a storage area in which the first profile information is recorded is regarded as first linkage position information, acquiring, during a time period ranging from the start of the execution of the first program to an end of the execution of the first program, the first profile information, and recording the first linkage position information into a first storage area that follows the second storage area.

With the above-described construction, a general hardware system such as a computer receives the profile information acquisition program via a computer-readable recording medium or a network connected to the computer, and executes the received profile information acquisition program. The hardware system then acquires pieces of profile information that are generated when software programs are executed, and records pieces of linkage position information, which indicate the lowest addresses of storage areas in which acquired pieces of profile information are recorded, into the linkage position information storage area allocated in the hardware system by arranging them in an order in which the software programs are executed. Such a construction provides an effect of facilitating tracing executions of the software programs since it enables one to indirectly trace, via the linkage position information, the address spaces in which the pieces of linkage position information are recorded in an arrangement that does not depend on the positions (for example, positions in a source code) at which the pieces of profile information are acquired. The construction also provides an effect of increasing development flexibility since the arrangement of the pieces of linkage position information in the linkage position information storage area is ensured regardless of the positions at which the pieces of profile information are acquired, even if the pieces of profile information are acquired at positions selected from a plurality of positions.

(22) In the above profile information acquisition program of (21), when information indicating a lowest address of a storage area in which no linkage position information is recorded and that is not reserved for recording linkage position information is regarded as end position information, and when information indicating a lowest address of a storage area that is reserved for recording linkage position information is regarded as reserved position information, the storage area allocating step may allocate hardware system spaces to (i) an end position information storage area for recording the end position information and (ii) a reserved position information storage area for recording the reserved position information by a First-In-Last-Out method, and when a pointer, which indicates an address in the linkage position information storage area at which the linkage position information starts to be recorded, is regarded as a recording start pointer, the second-profile-information acquiring step includes: a reserving substep for, when an address, which is indicated by the recording start pointer when the second storage area is allocated, is regarded as a second start address, and reserved position information indicating the second start address is regarded as second reserved position information, recording the second reserved position information into the reserved position information storage area, and shifting the recording start pointer upward from the second start address by a size of the second linkage position information; and a recording substep for, when an address, which is indicated by the recording start pointer when the second linkage position information is recorded, is regarded as a second end address, and end position information indicating the second end address is regarded as second end position information, recording the second end position information into the end position information storage area, reading the second reserved position information from the reserved position information storage area, moving the recording start pointer to the second start address indicated by the second reserved position information, recording the second linkage position information starting at the second start address toward upper addresses, reading the second end position information from the end position information storage area, and moving the recording start pointer to the second end address indicated by the second end position information.

The above-described construction, in which a storage area for recording a piece of linkage position information corresponding to a piece of profile information to be acquired is reserved in advance, has an effect that the arrangement of the pieces of linkage position information in the linkage position information storage area is ensured regardless of the positions at which the pieces of profile information are acquired. This construction also provides an effect of increasing development flexibility since the arrangement of the pieces of linkage position information in the linkage position information storage area is ensured regardless of the positions at which the pieces of profile information are acquired, even if the pieces of profile information are acquired at positions selected from a plurality of positions.

(23) In the above profile information acquisition program of (22), the first-profile-information acquiring step may allocate a space of the linkage position information storage area to the first storage area during a time period ranging from the start of the execution of the first program to the acquisition of the first linkage position information.

The above-described construction, in which not only a caller of a software program but the software program itself to be called reserves a storage area for recording linkage position information, provides an effect that the arrangement of the pieces of linkage position information in the linkage position information storage area is ensured when a system composed of a plurality of (three or more) layers operates on the hardware system. This construction also provides an effect of increasing development flexibility since the arrangement of the pieces of linkage position information in the linkage position information storage area is ensured regardless of the positions at which the pieces of profile information are acquired, even if the pieces of profile information are acquired at positions selected from a plurality of positions.

(24) In the above profile information acquisition program of (23), the first linkage position information and the second linkage position information may have either a same fixed length or different fixed lengths.

The above-described construction, in which pieces of linkage position information can be traced by the fixed size thereof, provides an effect of facilitating tracing executions of software programs. This construction also provides an effect of recording linkage position information that has a different size for each layer.

(25) In the above profile information acquisition program of (24), the reserving substep, when shifting the recording start pointer upward from the second start address, may write either (i) information indicating a reserved state or (ii) information indicating a layer to which the second program belongs, into the second storage area for the size of the second linkage position information.

The above-described construction provides an effect that if a process stops due to an unauthorized process or the like while linkage position information is recorded, it becomes information that indicates a problematic portion.

(26) The above object is also fulfilled by a profile information acquisition program for acquiring profile information generated in a hardware system under control of a software system having a hierarchical structure composed of layers of software programs including a first program and a second program, the second program calling and executing the first program, the profile information acquisition program comprising and causing the hardware system and the software system to execute the following steps cooperatively: a storage area allocating step for allocating a space of an external storage program, which is connected via a network to the hardware system, to a profile information storage area for recording the profile information; a second-profile-information acquiring step for, when profile information generated by execution of the second program is regarded as second profile information, allocating, during a time period ranging from a start of the execution of the second program to a start of execution, of the first program, a space of the profile information storage area to a second storage area for recording the second profile information, acquiring the second profile information, and recording the acquired second profile information into the second storage area; and a first-profile-information acquiring step for, when profile information generated by execution of the first program is regarded as first profile information, acquiring, during a time period ranging from the start of the execution of the first program to an end of the execution of the first program, the first profile information, and recording the acquired first profile information into a first storage area that follows the second storage area.

With the above-described construction, a general hardware system such as a computer receives the profile information acquisition program via a computer-readable recording medium or a network connected to the computer, and executes the received profile information acquisition program. The hardware system then acquires pieces of profile information that are generated when software programs are executed, and records the acquired pieces of profile information into the profile information storage area allocated in an external storage apparatus by arranging them in an order in which the software programs are executed. Such a construction provides an effect of facilitating tracing executions of the software programs since it enables one to directly trace the address spaces in which the pieces of profile information are recorded in an arrangement that does not depend on the positions (for example, positions in a source code) at which the pieces of profile information are acquired. This construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(27) The above object is also fulfilled by a profile information acquisition program for acquiring profile information generated in a hardware system under control of a software system having a hierarchical structure composed of layers of software programs including a first program and a second program, the second program calling and executing the first program, the profile information acquisition program comprising and causing the hardware system and the software system to execute the following steps cooperatively: a storage area allocating step for, when information indicating a lowest address of a storage area in which profile information is recorded is regarded as linkage position information, allocating a space of an external storage program, which is connected via a network to the hardware system, to a linkage position information storage area for recording the linkage position information; a second-profile-information acquiring step for, when profile information generated by execution of the second program is regarded as second profile information, and when linkage position information indicating a lowest address of a storage area in which the second profile information is recorded is regarded as second linkage position information, allocating, during a time period ranging from a start of the execution of the second program to a start of execution of the first program, a space of the linkage position information storage area to a second storage area for recording the second linkage position information, acquiring the second profile information, and recording the acquired linkage position information into the second storage area; and a first-profile-information acquiring step for, when profile information generated by execution of the first program is regarded as first profile information, and when linkage position information indicating a lowest address of a storage area in which the first profile information is recorded is regarded as first linkage position information, acquiring, during a time period ranging from the start of the execution of the first program to an end of the execution of the first program, the first profile information, and recording the first linkage position information into a first storage area that follows the second storage area.

With the above-described construction, a general hardware system such as a computer receives the profile information acquisition program via a computer-readable recording medium or a network connected to the computer, and executes the received profile information acquisition program. The hardware system then acquires pieces of profile information that are generated when software programs are executed, and records pieces of linkage position information, which indicate the lowest addresses of storage areas in which acquired pieces of profile information are recorded, into the linkage position information storage area allocated in an external storage apparatus by arranging them in an order in which the software programs are executed. Such a construction provides an effect of facilitating tracing executions of the software programs since it enables one to indirectly trace, via the linkage position information, the address spaces in which the pieces of linkage position information are recorded in an arrangement that does not depend on the positions (for example, positions in a source code) at which the pieces of profile information are acquired. The construction also provides an effect of increasing development flexibility since the arrangement of the pieces of linkage position information in the linkage position information storage area is ensured regardless of the positions at which the pieces of profile information are acquired, even if the pieces of profile information are acquired at positions selected from a plurality of positions.

(28) The above object is also fulfilled by a profile information acquisition system program composed of a profile information acquisition agent program and a profile information acquisition management program, the profile information acquisition agent program acquiring profile information generated in a hardware system under control of a software system having a hierarchical structure composed of layers of software programs including a first program and a second program, the second program calling and executing the first program, the profile information acquisition management program managing the profile information, the profile information acquisition agent program comprising: a second-profile-information acquiring step for, when profile information generated by execution of the second program is regarded as second profile information, instructing, during a time period ranging from a start of the execution of the second program to a start of execution of the first program, to create a second reserve message that indicates that the second profile information is to be transmitted later, acquiring the second profile information, and instructing to create a second record message containing the second profile information; a first-profile-information acquiring step for, when profile information generated by execution of the first program is regarded as first profile information, acquiring, during a time period ranging from the start of the execution of the first program to an end of the execution of the first program, the first profile information, and instructing to create a first record message containing the first profile information; a message creation step for creating a message ID that is identification information created uniquely for each message so as to increase in time series, creating the second reserve message together with a message containing (i) a message ID of the second reserve message and (ii) a size of the second profile information, temporarily store the message ID of the second reserve message as position information, creating the first record message together with a message containing (i) a message ID of the first record message and (ii) the first profile information, and creating the second record message together with a message containing (i) a message ID of the second record message and (ii) the second profile information; and a message transmission step for transmitting messages to the profile information acquisition management program in an order in which the messages are created, the profile information acquisition management program comprising: a message reception step for receiving a message from the profile information acquisition agent program; a message response step for analyzing the received message, if the received message is found to be the second reserve message, creating dummy data in accordance with the second reserve message, instructing to record the dummy data into a profile information database instead of the second reserve message, and instructing to register the message ID contained in the second reserve message with a position information database as position information, and if the received message is found to be the second record message, instructing to replace the dummy data recorded in the profile information database with the second profile information contained in the second record message; a position information management step for creating an entry ID that is identification information created uniquely for each piece of point information and increases in time series, and registering the point information with the position information database in a manner in which the point information is correlated with the entry ID; and a profile information management step for creating a record ID that is identification information created uniquely for each piece of profile information and increases in time series, and recording the dummy data into the profile information database in a manner in which the dummy data is correlated with the record ID, and replacing the dummy data, which is correlated with the record ID, with the second profile information.

With the above-described construction, general hardware systems such as computers receive the profile information acquisition system program via a computer-readable recording medium or a network connected to the computer, and execute the received profile information acquisition system program. A hardware system having executed the profile information acquisition agent program acquires pieces of profile information that are generated when software programs are executed, and transmits the acquired pieces of profile information to a hardware system having executed the profile information acquisition management program. The hardware system having executed the profile information acquisition management program manages the pieces of profile information by arranging them in an order in which the software programs are executed. Such a construction provides an effect of facilitating tracing executions of the software programs since the arrangement of the pieces of profile information managed by the profile information acquisition management apparatus is ensured, not depending on the positions (for example, positions in a source code) at which the pieces of profile information are acquired. The construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(29) The above object is also fulfilled by a profile information acquisition agent program for acquiring profile information generated in a hardware system under control of a software system having a hierarchical structure composed of layers of software programs including a first program and a second program, the second program calling and executing the first program, the profile information acquisition agent program comprising: a second-profile-information acquiring step for, when profile information generated by execution of the second program is regarded as second profile information, instructing, during a time period ranging from a start of the execution of the second program to a start of execution of the first program, to create a second reserve message that indicates that the second profile information is to be transmitted later, acquiring the second profile information, and instructing to create a second record message containing the second profile information; a first-profile-information acquiring step for, when profile information generated by execution of the first program is regarded as first profile information, acquiring, during a time period ranging from the start of the execution of the first program to an end of the execution of the first program, the first profile information, and instructing to create a first record message containing the first profile information; a message creation step for creating a message ID that is identification information created uniquely for each message so as to increase in time series, creating the second reserve message together with a message containing (i) a message ID of the second reserve message and (ii) a size of the second profile information, temporarily store the message ID of the second reserve message as position information, creating the first record message together with a message containing (i) a message ID of the first record message and (ii) the first profile information, and creating the second record message together with a message containing (i) a message ID of the second record message and (ii) the second profile information; and a message transmission step for transmitting messages to a profile information acquisition management program for managing the profile information, in an order in which the messages are created.

With the above-described construction, a general hardware system such as a computer receives the profile information acquisition agent program via a computer-readable recording medium or a network connected to the computer, and executes the received profile information acquisition agent program. The hardware system acquires pieces of profile information that are generated when software programs are executed, and transmits the acquired pieces of profile information to a profile information acquisition management apparatus. The profile information acquisition management apparatus manages the pieces of profile information by arranging them in an order in which the software programs are executed. Such a construction provides an effect of facilitating tracing executions of the software programs since the arrangement of the managed pieces of profile information is ensured, not depending on the positions (for example, positions in a source code) at which the pieces of profile information are acquired. The construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

(30) The above object is also fulfilled by a profile information acquisition management program for managing profile information generated in a hardware system under control of a software system having a hierarchical structure composed of layers of software programs including a first program and a second program, the second program calling and executing the first program, the profile information acquisition management program comprising: a message reception step for receiving a message from a profile information acquisition agent program that acquires the profile information; a message response step for, when profile information generated by execution of the second program is regarded as second profile information, when a message indicating that the second profile information is to be transmitted later is regarded as a second reserve message, and when a message containing the second profile information is regarded as a second record message, analyzing the received message, if the received message is found to be the second reserve message, creating dummy data in accordance with the second reserve message, instructing to record the dummy data into a profile information database instead of the second reserve message, and instructing to register the message ID contained in the second reserve message with a position information database as position information, and if the received message is found to be the second record message, instructing to replace the dummy data recorded in the profile information database with the second profile information contained in the second record message; a position information management step for creating an entry ID that is identification information created uniquely for each piece of point information and increases in time series, and registering the point information with the position information database in a manner in which the point information is correlated with the entry ID; and a profile information management step for creating a record ID that is identification information created uniquely for each piece of profile information and increases in time series, and recording the dummy data into the profile information database in a manner in which the dummy data is correlated with the record ID, and replacing the dummy data, which is correlated with the record ID, with the second profile information.

With the above-described construction, a general hardware system such as a computer receives the profile information acquisition management program via a computer-readable recording medium or a network connected to the computer, and executes the received profile information acquisition management program. A profile information acquisition agent apparatus acquires pieces of profile information that are generated when software programs are executed, and transmits the acquired pieces of profile information to the profile information acquisition management apparatus. The profile information acquisition management apparatus manages the pieces of profile information by arranging them in an order in which the software programs are executed. Such a construction provides an effect of facilitating tracing executions of the software programs since the arrangement of the managed pieces of profile information is ensured, not depending on the positions (for example, positions in a source code) at which the pieces of profile information are acquired. The construction also provides an effect of increasing development flexibility since the arrangement of the acquired pieces of profile information in the profile information storage area is ensured regardless of the positions at which the pieces of profile information are acquired, even if the pieces of profile information are acquired at positions selected from a plurality of positions.

### CONCLUSION

As understood from the above descriptions of (1) through (30), the profile information acquisition program or apparatus of the present invention solves the problem that in a software system having a hierarchy structure, pieces of profile information are not recorded in an order in which processes shift. Furthermore, the present invention solves a problem that a method of acquiring and recording profile information before shifting to a lower layer may not record correct profile information depending on the dependency of variables, functions or the like. The present invention also solves a problem that when pieces of profile information are acquired at positions selected from a plurality of positions, the order in which the pieces of profile information are recorded changes depending on the selection of the positions. Accordingly, the present invention solves the problem that tracing the executions of software programs is difficult, which occurs because pieces of profile information are not recorded in an order in which processes shift.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1A shows a hardware system structure of a profile information acquisition apparatus;

FIG. 1B shows a software system structure;

FIG. 2 shows how address spaces in the RAM 103 are allocated by the software system 105;

FIG. 3 is a functional block diagram of the profile information acquisition apparatus in Embodiment 1;

FIG. 4 is a flowchart of the system call A;

FIG. 5A is a flowchart of the storage area reserving process in Embodiment 1;

FIG. 5B is a flowchart of the profile information recording process in Embodiment 1;

FIGS. 6A-6F show the transition of the recording start pointer when the system call A is executed;

FIG. 7 shows how address spaces in the RAM 103 are allocated by the software system 105;

FIG. 8 is a functional block diagram of the profile information acquisition apparatus in Embodiment 2;

FIG. 9A is a flowchart of the storage area reserving process in Embodiment 2;

FIG. 9B is a flowchart of the profile information recording process in Embodiment 2;

FIGS. 10A-10F show the transition of the recording start pointer when the system call A is executed;

FIG. 11 is a schematic illustration of the profile information acquisition system in Embodiment 3;

FIG. 12 is a sequence diagram showing establishment of an encryption communication between the profile information acquisition agent apparatus and the profile information acquisition management apparatus in the Application Layer;

FIG. 13 is a schematic illustration of a list of household electric appliances connected to the network, which is displayed on a screen of an IP phone as a result of a neighborhood search;

FIG. 14A is a deployment diagram showing the internal construction of the profile information acquisition agent apparatus;

FIG. 14B is a deployment diagram showing the internal construction of the profile information acquisition management apparatus;

FIG. 15 is a state chart showing the state transition in the profile information acquisition agent apparatus;

FIG. 16 is a state chart showing the state transition in the profile information acquisition management apparatus;

FIG. 17A shows the data structure of the reserve message;

FIG. 17B shows the data structure of the record message;

FIG. 18A shows the data structure of the position information record which is stored in the position information database;

FIG. 18B shows the data structures of the profile information record which is stored in the profile information database;

FIG. 19 is a functional block diagram showing the construction of the profile information acquisition agent apparatus when the profile information acquisition agent program is executed;

FIG. 20 is a functional block diagram showing the construction of the profile information acquisition management apparatus when the profile information acquisition management program is executed;

FIG. 21 shows partial constructions of the profile information acquisition agent apparatus and the profile information acquisition management apparatus;

FIG. 22A is an activity diagram showing the storage area reserve process in Embodiment 3;

FIG. 22B an activity diagram showing the profile information recording process in Embodiment 3;

FIG. 23A is an activity diagram showing the reserve message creation process in Embodiment 3;

FIG. 23B is an activity diagram showing the record message creation process in Embodiment 3;

FIG. 24 is an activity diagram showing the reserve message response process in Embodiment 3;

FIG. 25 is an activity diagram showing the first part of the record message response process in Embodiment 3;

FIG. 26 is an activity diagram showing the second part of the record message response process in Embodiment 3;

FIG. 27 is an activity diagram showing the first part of the position information management process in Embodiment 3;

FIG. 28 is an activity diagram showing the second part of the position information management process in Embodiment 3;

FIG. 29 is an activity diagram showing the profile information management process in Embodiment 3;

FIG. 30 is a sequence diagram showing a sequence of messages transmitted when the system call A is executed; and

FIGS. 31 and 32 show examples of reserve and record messages.

### DESCRIPTION OF THE PREFERRED EMBODIMENT

Embodiment 1

An embodiment of the present invention will be described with reference to the related drawings.

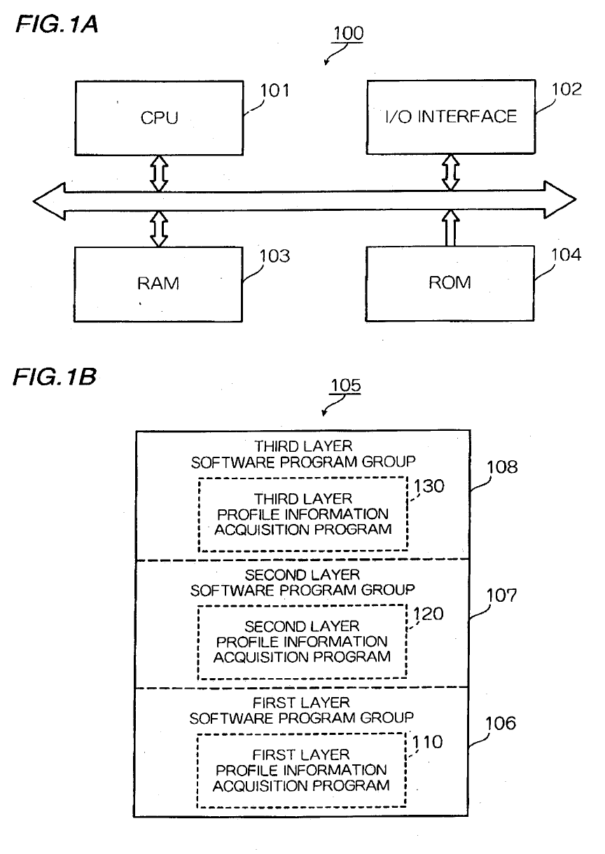

FIG. 1A shows a hardware system structure of a profile information acquisition apparatus. FIG. 1B shows a software system structure.

As shown in FIG. 1A, a hardware system 100 includes a CPU (Central Processing Unit) 101, an I/O interface 102, a RAM 103, and a ROM 104. More specifically, the hardware system 100 is an industrial machine or a digital household electric appliance.

The CPU 101 executes processes for software systems as will be described later.

The I/O interface 102 inputs and outputs data from/to a peripheral device (not illustrated) connected to the hardware system 100. The I/O interface 102 is achieved by, for example, an infrared communication port, a short-haul radio transmission interface (for example, Bluetooth), an USB (Universal Serial Bus) interface, an IEEE (Institute of Electric and Electronics Engineers) 1394 interface, a network interface.

The RAM 103 is a semiconductor memory from/on which data is read or written as necessary. The RAM 103 is achieved by, for example, a DRAM (Dynamic Random Access Memory) or an SPAM (Static Random Access Memory).

The ROM 104 is a read-only memory. The ROM 104 is achieved by, for example, a mask ROM onto which data is written when it is produced, a PROM (Programmable Read Only Memory) onto which a user can write a program electrically, or an EPROM (Erasable and Programmable Read Only Memory) onto which a dedicated apparatus can rewrite data.

As shown in FIG. 1B, a software system 105 includes a first layer software program group 106, a second layer software program group 107, and a third layer software program group 108.

It should be noted here that the software system 105 is stored in the ROM 104, with the third layer software program group 108 being the uppermost layer.

The first layer software program group 106 is an operating system and is composed of programs for inter-process communication, memory management, management and scheduling of lower-level processes, and processing of lower-level input/output. Hereinafter, the programs that constitute the first layer software program group 106 are referred to as first layer programs.

The first layer software program group 106 further includes a first layer profile information acquisition program 110. The first layer profile information acquisition program 110 is a program for acquiring the profile information (hereinafter referred to as first layer profile information) that is generated while the CPU 101 processes the first layer programs.

It should be noted here that the profile information shows a program execution history and includes data concerning each module, function, method, or system call, the data being, for example: (a) an execution time; (b) the number of executions of statements (steps); (c) the number of branches for each of true and false at each branch; (d) a variable value; and (e) memory use state.

The second layer software program group 107 is an emulator and, for example, converts a system call contained in an operating system other than the first layer software program group 106 to a system call contained in the first layer software program group 106.

It should be noted here that the system call is an interface between an operating system and a user program, and is an extended instruction contained in the operating system.

Hereinafter, the programs that constitute the second layer software program group 107 are referred to as second layer programs.

The second layer software program group 107 further includes a second layer profile information acquisition program 120. The second layer profile information acquisition program 120 is a program for acquiring the profile information (hereinafter referred to as second layer profile information) that is generated while the CPU 101 processes the second layer programs.

The third layer software-program group 108 is composed of a plurality of user programs that are, for example, written by system calls contained in the second layer software program group 107. Hereinafter, the programs that constitute the third layer software program group 108 are referred to as third layer programs.

The third layer software program group 108 further includes a third layer profile information acquisition program 130. The third layer profile information acquisition program 130 is a program for acquiring the profile information (hereinafter referred to as third layer profile information) that is generated while the CPU 101 processes the third layer programs.

It should be noted here that the hardware system 100 executes a user program when it receives an instruction to execute the user program, from the user via the I/O interface 102. When a user program is executed, the hardware system 100 causes the CPU 101 to call the first, second, and third layer programs from the RAM 103 and the ROM 104 and execute the called programs.

It is supposed here that during execution of a user program, if, while executing a certain program of a certain layer, the CPU 101 calls another program of another layer, the CPU 101 first executes the called program and then returns to the program from which the other program was called.

When power is applied to the hardware system 100, the software system 105 is read from the ROM 104 and stored into the RAM 103. Then after the profile information acquisition function becomes effective for the acquisition apparatus, the software system 105 allocates a storage area in the RAM 103 to recording of the profile information acquisition program and profile information for each layer.

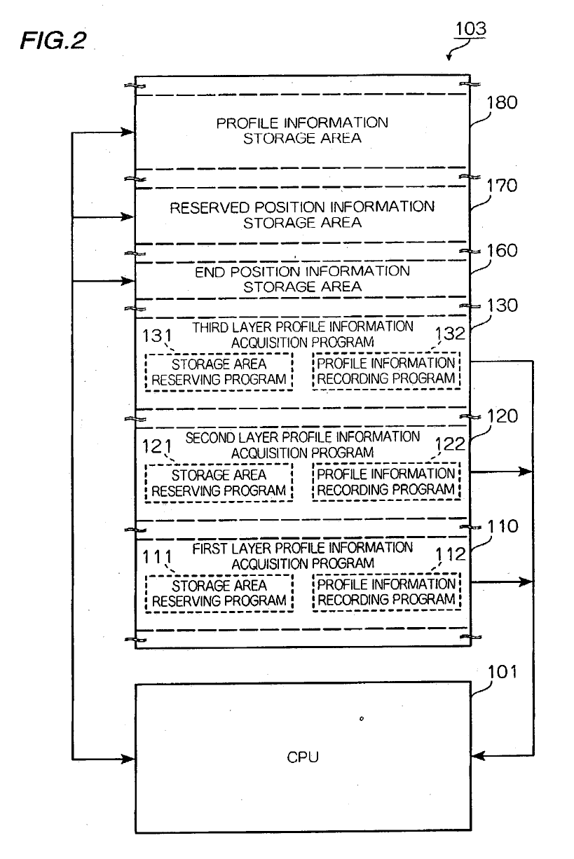

FIG. 2 shows how address spaces in the RAM 103 are allocated by the software system 105.

As shown in FIG. 2, the following areas in the RAM 103 are assigned to the software system 105 in the order from the lowest address to the uppermost address: a storage area for recording the first layer profile information acquisition program 110; a storage area for recording the second layer profile information acquisition program 120; a storage area for recording the third layer profile information acquisition program 130; an end position information storage area 160; a reserved position information storage area 170; and a profile information storage area 180.

The first layer profile information acquisition program 110, second layer profile information acquisition program 120, and third layer profile information acquisition program 130 have the same function that is achieved when the programs are executed. Here, only the function of the second layer profile information acquisition program 120 will be explained as an example and the others will be omitted.

Though not illustrated, various pieces of data, which are generated as user programs read by the CPU 101 from the RAM 103 are executed, are stored in allocated storage areas in the RAM 103.

The second layer profile information acquisition program 120 is a program group for acquiring the second layer profile information and recording the acquired information onto the profile information storage area 180.

The second layer profile information acquisition program 120 is composed of a storage area reserving program 121 and a profile information recording program 122.

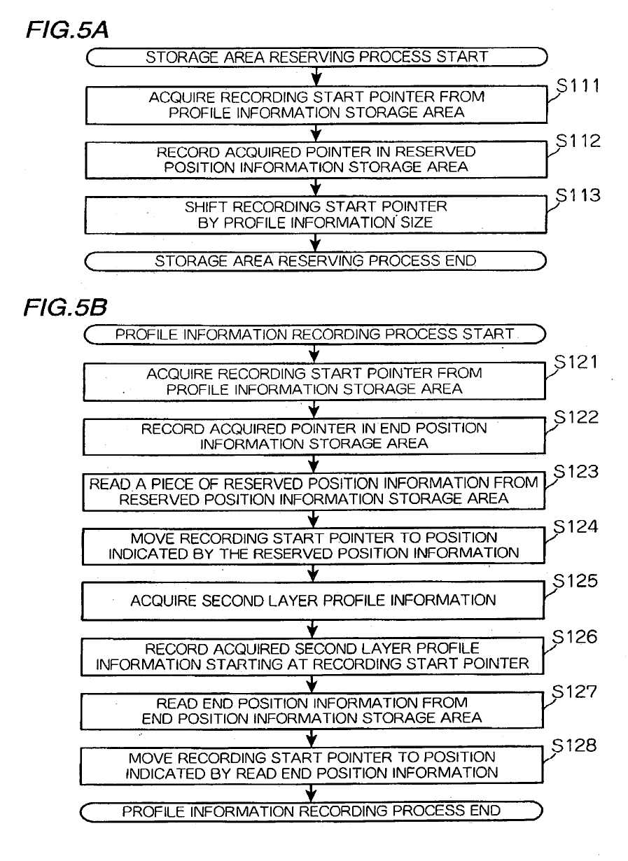

The storage area reserving program 121 is a program for causing the CPU 101 to perform a storage area reserving process. In the storage area reserving process, a storage area in the profile information storage area 180 is reserved for recording an acquired piece of profile information. The storage area reserving process will be described in detail later with reference to FIG. 5A.

The profile information recording program 122 is a program for causing the CPU 101 to perform a profile information recording process. Note that acquired second layer profile information is recorded in a storage area that is reserved by the storage area reserving program 121.

In the profile information recording process, acquired pieces of profile information are recorded in the storage areas reserved by the storage area reserving process, in the order from the lowest address to the uppermost address. The profile information recording process will be described in detail later with reference to FIG. 5B.

The end position information storage area 160 is a storage area in which the end position information is recorded.

The end position information indicates the uppermost address of the storage areas recording the profile information in the profile information storage area 180.

The reserved position information storage area 170 stores pieces of reserved position information by the First-In-Last-Out method.

The reserved position information indicates the lowest address of the storage areas reserved by the storage area reserving program 121 in the profile information storage area 180

The profile information storage area 180 is composed of consecutive areas of address spaces allocated for recording the profile information.

Hereinafter, a profile information acquisition apparatus refers to an apparatus that is achieved by the hardware system 100 having read the software system 105 from the ROM 104 and executed the profile information acquisition programs 110, 120, and 130 contained in the read software system 105.

Construction of Profile Information Acquisition Apparatus

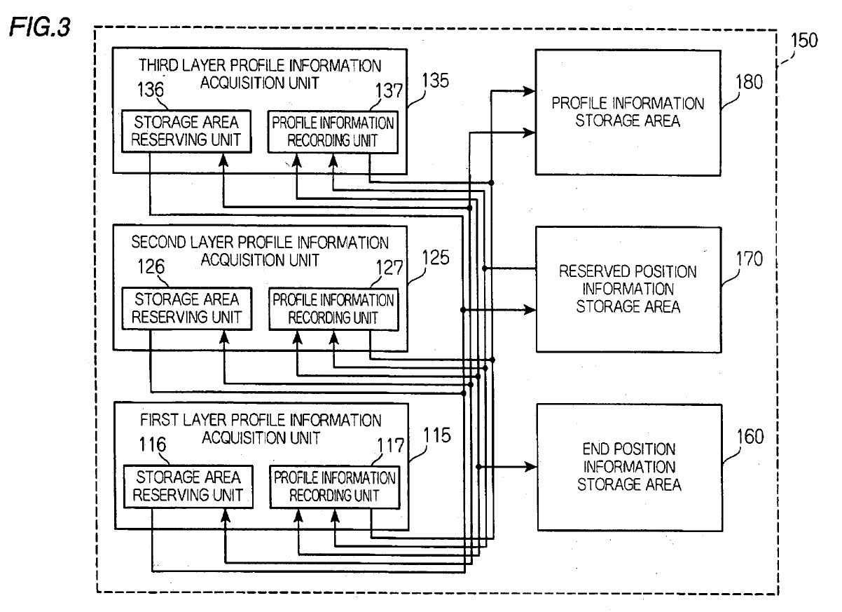

FIG. 3 is a functional block diagram of the profile information acquisition apparatus in Embodiment 1.

As shown in FIG. 3, a profile information acquisition apparatus 150 is composed of a first layer profile information acquisition unit 115, a second layer profile information acquisition unit 125, a third layer profile information acquisition unit 135, the end position information storage area 160, the reserved position information storage area 170, and the profile information storage area 180.

The first layer profile information acquisition unit 115, second layer profile information acquisition unit 125, and third layer profile information acquisition unit 135 have the same construction and operation. Here, only the construction and operation of the second layer profile information acquisition unit 125 will be described and the others will be omitted.

The second layer profile information acquisition unit 125 is a function achieved by the CPU 101 having executed the second layer profile information acquisition program 120. The second layer profile information acquisition unit 125 is composed of a storage area reserving unit 126 and a profile information recording unit 127.

The storage area reserving unit 126 is a function achieved by the CPU 101 having executed the storage area reserving program 121.

The profile information recording unit 127 is a function achieved by the CPU 101 having executed the profile information recording program 122.

Operation of Profile Information Acquisition Apparatus

The operation of the profile information acquisition apparatus 150 with the construction as described above will be explained. In this explanation of the operation, a system call A, which is a software program contained in the second layer software program group 107, will be used as an example. Also, it is supposed for the sake of convenience that the profile information has a fixed length in size.

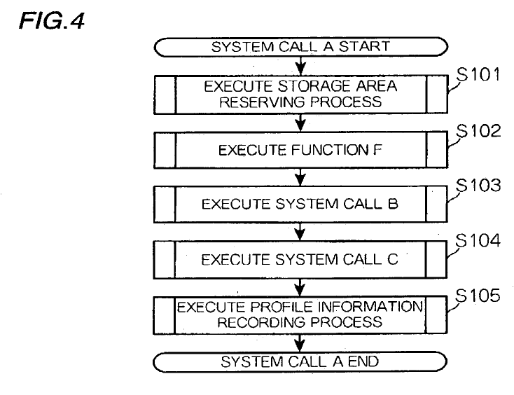

FIG. 4 is a flowchart of the system call A.

As shown in FIG. 4, the system call A executes the storage area reserving process (step S101) executes a function F (step S102), executes system calls B and C contained in the first layer software program group 106 (step S103 and S104), and executes the profile information recording process (step S105).

The system calls A to C generate the profile information as they are executed. The profile information generated by the system call A is acquired by the second layer profile information acquisition unit 125, and the profile information generated by the system calls B and C is acquired by the first layer profile information acquisition unit 115. The function F generates the profile information as it is executed, but the profile information generated by the function F is not acquired by any profile information acquisition unit of the layers.

Storage Area Reserving Process and Profile Information Recording Process

FIG. 5A is a flowchart of the storage area reserving process in Embodiment 1. FIG. 5B is a flowchart of the profile information recording process in Embodiment 1.

Storage Area Reserving Process

As shown in FIG. 5A, the storage area reserving unit 126 acquires a recording start pointer from the profile information storage area 180 (step S111), and records the acquired recording start pointer in the reserved position information storage area 170 as the reserved position information (step S112).

Here, the recording start pointer indicates the lowest address of a storage area allocated for recording the profile information in the profile information storage area 180.

The storage area reserving unit 126 then shifts the recording start pointer by the size of the profile information (step S113).

The storage area reserving units 116 and 136 also operate in the same manner as the storage area reserving unit 126.

Profile Information Recording Process

As shown in FIG. 5B, the profile information recording unit 127 acquires the recording start pointer from the profile information storage area 180 (step S121), and records the acquired recording start pointer in the end position information storage area 160 as the end position information (step S122). The profile information recording unit 127 then reads a piece of reserved position information from the reserved position information storage area 170 (step S123), and moves the recording start pointer to the address indicated by the read piece of reserved position information (step S124). The profile information recording unit 127 then acquires the second layer profile information (step S125), and records the acquired second layer profile information onto the reserved storage area starting at the address indicated by the recording start pointer (step S126). The profile information recording unit 127 then reads the end position information from the end position information storage area 160 (step S127), and moves the recording start pointer to the address indicated by the read end position information (step S128).

The profile information recording units 117 and 137 also operate in the same manner as the profile information recording unit 127.

Operation Example

Now, how the profile information is recorded in the profile information storage area 180 when the CPU 101 executes the system call A will be described. It is supposed here that the addresses in the RAM 103 are represented by 32-bit values, and that the profile information storage area 180 has a capacity of 16 megabytes between the lowest address 0x0100000h and the uppermost address 0x02000000h in hexadecimal notation.

In the following description, it is supposed that each piece of profile information has a fixed length of 256 bytes.

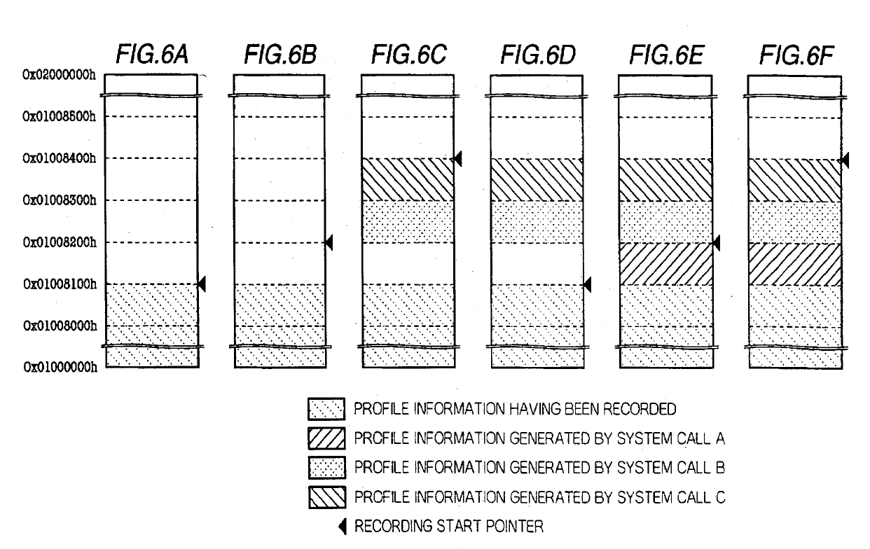

FIGS. 6A-6F show the transition of the recording start pointer when the system call A is executed.

As shown in FIGS. 6A-6F, the profile information storage area 180 ranges from the lowest address 0x01000000h to the uppermost address 0x02000000h. Each piece of profile information is recorded in the profile information storage area 180 in the order from the lowest address to the uppermost address.

As shown in FIG. 6A, the recording start pointer indicates address 0x01008100h before the system call A is executed.

In step S101, the system call A executes the storage area reserving process.

In step S111, the storage area reserving unit 126 acquires the recording start pointer (0x01008100h) from the profile information storage area 180.

In step S112, the storage area reserving unit 126 records the acquired recording start pointer (0x01008100h) in the reserved position information storage area 170 as the reserved position information.

In step S113, the storage area reserving unit 126 shifts the recording start pointer by the size of the second layer profile information.

As shown in FIG. 6B, the recording start pointer indicates address 0x01008200h after the step S113.

In step S102, the system call A executes a function F, and in step S103, executes system call B contained in the first layer software program group 106.

The profile information recording unit 127 acquires a piece of profile information generated for the system call B, and records the acquired profile information in a storage area ranging from 0x01008200h to 0x010082ffh.

In step S104, the system call A executes system call C contained in the first layer software program group 106.

The profile information recording unit 127 acquires a piece of profile information generated for the system call C, and records the acquired profile information in a storage area ranging from 0x01008300h to 0x010083ffh.

As shown in FIG. 6C, the recording start pointer indicates address 0x01008400h after the step S104.

In step S105, the system call A executes the profile information recording process.

In step S121, the profile information recording unit 127 acquires the recording start pointer (0x01008400h) from the profile information storage area 180.

In step S122, the profile information recording unit 127 records the acquired recording start pointer (0x01008400h) in the end position information storage area 160 as the end position information.

In step S123, the profile information recording unit 127 reads a piece of reserved position information from the reserved position information storage area 170.

In step S124, the profile information recording unit 127 moves the recording start pointer to the address (0x01008100h) indicated by the read piece of reserved position information.

In step S125, the profile information recording unit 127 acquires the second layer profile information.

In step S126, the profile information recording unit 127 records the acquired second layer profile information onto the reserved storage area starting with the address (0x01008100h) indicated by the recording start pointer.

As shown in FIG. 6E, the recording start pointer indicates address 0x01008200h after the step S126.

In step S127, the profile information recording unit 127 reads the end position information from the end position information storage area 160.

In step S128, the profile information recording unit 127 moves the recording start pointer to the address (0x01008400h) indicated by the read end position information.

As shown in FIG. 6F, the recording start pointer indicates address 0x01008400h after the step S128.

With this, execution of the system call A is completed.

Others for Embodiment 1

The address spaces may be real address spaces or virtual address spaces.

Here, the real address spaces are address spaces allocated as physical storage units in the RAM 103. The virtual address spaces are address spaces that can be virtually specified by each software program.

The profile information may have a variable length, instead of a fixed length. The profile information may have a fixed length that is different for each layer. The profile information may have a fixed length that is different for each software program group.

A plurality of software program groups may exist in the same layer. This applies to, for example, a case in which a plurality of operating systems are emulated by a plurality of emulators that corresponding to the operating systems on a one-to-one basis.

In the above execution of system call A, the profile information is acquired and recorded in the profile information record step written after the system call C. However, a plurality of profile information record steps may be written before, after, and between the system calls B and C, one of the plurality of profile information record steps may be selected depending on certain conditions, and the profile information may be acquired and recorded in the selected profile information record step.

The profile information acquisition program may be recorded in a computer-readable recording medium such as an optical recording medium (for example, CD-ROM), a magnetic recording medium (for example, a hard disk), a magneto-optical recording medium (for example, MO), or a semiconductor memory (for example, ROM), and may be executed by another computer. Alternatively, the profile information acquisition program may be recorded in a computer-readable recording medium (such as a hard disk) provided in a general hardware system (such as a computer) connected to a network, and may be executed by another computer that reads the profile information acquisition program from the computer-readable recording medium via the network or another transmission path.

The profile information acquisition apparatus 150 may allocate a profile information storage area in (i) a computer-readable recording apparatus such as a hard disk connected to the profile information acquisition apparatus 150 via the I/O interface 102 or (ii) a computer-readable recording apparatus such as a RAM or a hard disk installed in a general hardware apparatus such as a computer connected to the profile information acquisition apparatus 150 via a network, instead of in the RAM 103, and write the profile information onto the allocated profile information storage area. Also, only the profile information of a certain layer may be written to the profile information storage area.

The profile information acquisition apparatus 150, upon receiving a transfer request from the user of the profile information acquisition apparatus 150 via the I/O interface 102, may transfer (dump) the profile information, which is recorded in the profile information storage area 180, to a transfer destination. Alternatively, the profile information recorded in the profile information storage area 180 may be automatically transferred when the recorded amount exceeds a predetermined value.

The transfer destination may be registered in advance, or specified when a transfer request is received.

Embodiment 2

Another embodiment, Embodiment 2, of the present invention will be described with reference to the related drawings. In the description of Embodiment 2, the same reference numbers as those appearing in Embodiment 1 indicate the same components or operations and explanation of such is omitted.

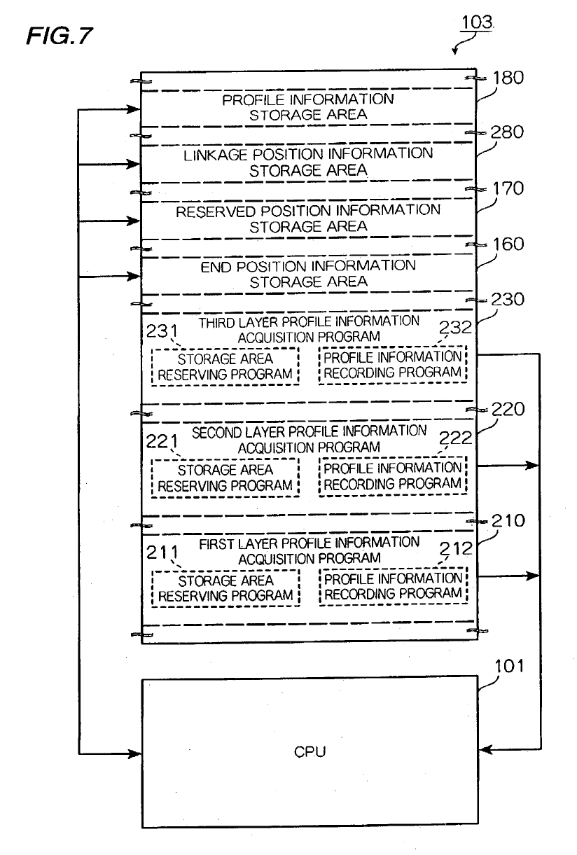

FIG. 7 shows how address spaces in the RAM 103 are allocated to the software system 105.

The space allocation shown in FIG. 7 differs from that shown in FIG. 2 in that storage areas for recording a first layer profile information acquisition program 210, a second layer profile information acquisition program 220, and a third layer profile information acquisition program 330 replace the storage areas for recording the first layer profile information acquisition program 110, second layer profile information acquisition program 120, and third layer profile information acquisition program 130, and that a linkage position information storage area 280 is allocated additionally.

The first layer software program group 106 includes a first layer profile information acquisition program 210 for acquiring the first layer profile information, instead of the first layer profile information acquisition program 110.

The second layer software program group 107 includes a second layer profile information acquisition program 220 for acquiring the second layer profile information, instead of the second layer profile information acquisition program 120.

The third layer software program group 108 includes a third layer profile information acquisition program 230 for acquiring the third layer profile information, instead of the third layer profile information acquisition program 130.

The first layer profile information acquisition program 210, second layer profile information acquisition program 220, and third layer profile information acquisition program 230 have the same function that is achieved when the programs are executed. Here, only the function of the second layer profile information acquisition program 220 will be explained as an example and the others will be omitted.

The second layer profile information acquisition program 220 is composed of a storage area reserving program 221 and a profile information recording program 222.

The storage area reserving program 221 is a program for causing the CPU 101 to perform the storage area reserving process.

The profile information recording program 222 is a program for causing the CPU 101 to perform the profile information recording process.

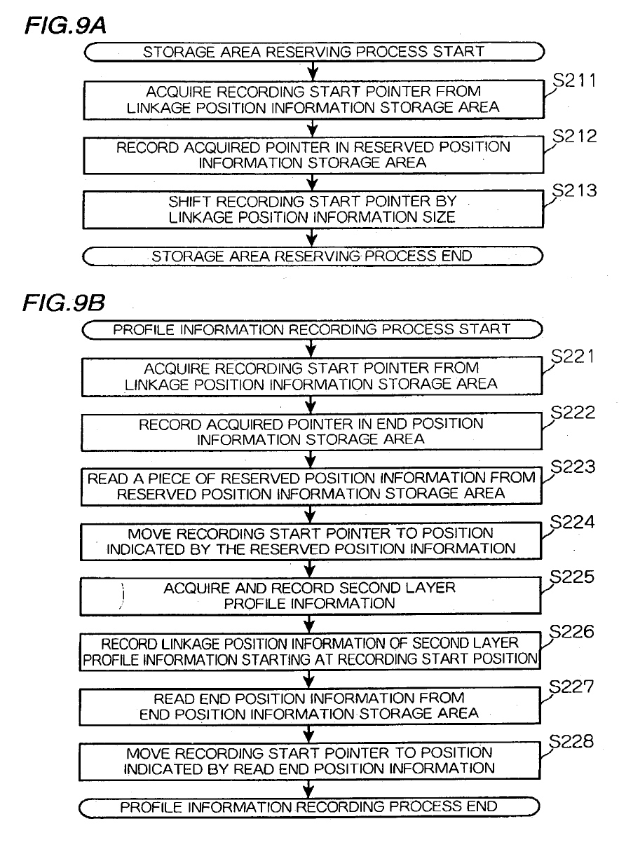

The storage area reserving process in Embodiment 2 is different from that in Embodiment 1. In the storage area reserving process in Embodiment 2, a storage area in the linkage position information storage area 280 is reserved for recording the linkage position information. The storage area reserving process in Embodiment 2 will be described in detail later with reference to FIG. 9A.

Here, the linkage position information indicates the lowest address of a storage area in which the profile information has been recorded or is to be recorded.

The profile information recording process in Embodiment 2 is different from that in Embodiment 1. In the profile information recording process in Embodiment 2, acquired pieces of profile information are recorded in the storage areas in the profile information storage area 180 in the order from the lowest address to the uppermost address. Then, pieces of linkage position information corresponding to the recorded pieces of profile information are recorded in the linkage position information storage area 280. With this construction, pieces of profile information are indirectly linked by the linkage position information. The profile information recording process in Embodiment 2 will be described later in detail with reference to FIG. 9B.

The end position information in Embodiment 2 is different from that in Embodiment 1. The end position information in Embodiment 2 indicates the uppermost address of the storage area recording the linkage position information in the linkage position information storage area 280.

The reserved position information in Embodiment 2 is different from that in Embodiment 1. The reserved position information in Embodiment 2 indicates the lowest address of the storage area reserved for recording the linkage position information in the linkage position information storage area 280.

Construction of Profile Information Acquisition Apparatus

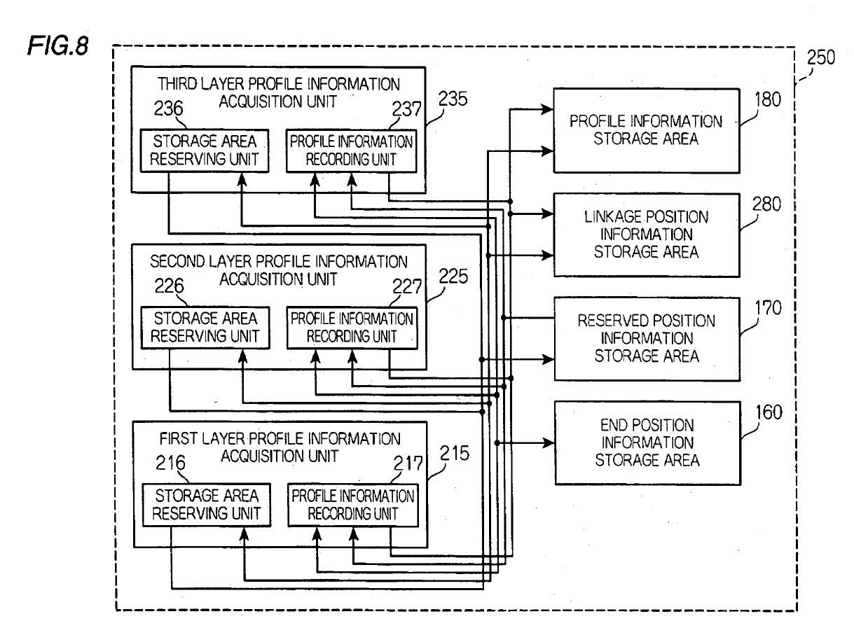

FIG. 8 is a functional block diagram of the profile information acquisition apparatus in Embodiment 2.

As shown in FIG. 3, a profile information acquisition apparatus 250 differs from the profile information acquisition apparatus 150 in that it includes a first layer profile information acquisition unit 215, a second layer profile information acquisition unit 225, and a third layer profile information acquisition unit 235 instead of the first layer profile information acquisition unit 115, second layer profile information acquisition unit 125, and third layer profile information acquisition unit 135, and that it additionally includes the linkage position information storage area 280.

The first layer profile information acquisition unit 215, second layer profile information acquisition unit 225, and third layer profile information acquisition unit 235 have the same construction and operation. Here, only the construction and operation of the second layer profile information acquisition unit 225 will be described and the others will be omitted.

The second layer profile information acquisition unit 225 is a function achieved by the CPU 101 having executed the second layer profile information acquisition program 220. The second layer profile information acquisition unit 225 is composed of a storage area reserving unit 226 and a profile information recording unit 227.

The storage area reserving unit 226 is a function achieved by the CPU 101 having executed the storage area reserving program 221.

The profile information recording unit 227 is a function achieved by the CPU 101 having executed the profile information recording program 222.

Operation of Profile Information Acquisition Apparatus

The operation of the profile information acquisition apparatus 250 with the construction as described above will be explained. In this explanation of the operation, the system call A introduced in Embodiment 1 will be used as an example. In the following description, the storage area reserving process and the profile information recording process refer to those in Embodiment 2.

Storage Area Reserving Process and Profile Information Recording Process

FIG. 9A is a flowchart of the storage area reserving process in Embodiment 2. FIG. 9B is a flowchart of the profile information recording process in Embodiment 2.

Storage Area Reserving Process

As shown in FIG. 9A, the storage area reserving unit 226 acquires a recording start pointer from the linkage position information storage area 280 (step S211), and records the acquired recording start pointer in the reserved position information storage area 170 as the reserved position information (step S212).

Here, the recording start pointer in Embodiment 2 differs from that in Embodiment 1 in that it indicates the lowest address of a storage area allocated for recording a piece of linkage position information, which indicates the address of an acquired piece of profile information, in the linkage position information storage area 280.

The storage area reserving unit 226 then shifts the recording start pointer by the size of the linkage position information (step S213).

Profile Information Recording Process

As shown in FIG. 9B, the profile information recording unit 227 acquires the recording start pointer from the linkage position information storage area 280 (step S221), and records the acquired recording start pointer in the end position information storage area 160 as the end position information (step S222). The profile information recording unit 227 then reads a piece of reserved position information from the reserved position information storage area 170 (step S223), and moves the recording start pointer to the address indicated by the read piece of reserved position information (step S224). The profile information recording unit 227 then acquires the second layer profile information and records the acquired second layer profile information in the profile information storage area 180 (step S225). The profile information recording unit 227 then records a piece of linkage position information, which indicates the address of the acquired second layer profile information, in the linkage position information storage area 280 starting with the address indicated by the recording start pointer (step S226). The profile information recording unit 227 then reads the end position information from the end position information storage area 160 (step S227), and moves the recording start pointer to the address indicated by the read end position information (step S228).

Operation Example

Now, how the linkage position information is recorded in the linkage position information storage area 280 when the CPU 101 executes the system call A will be described. It is supposed here that the addresses in the RAM 103 are represented by 32-bit values, and that the linkage position information storage area 280 has a capacity of 4 kilobytes between the lowest address 0x00800000h and the uppermost address 0x00801000h in hexadecimal notation.

In the following description, it is supposed that each piece of profile information has a fixed length of 4 bytes.

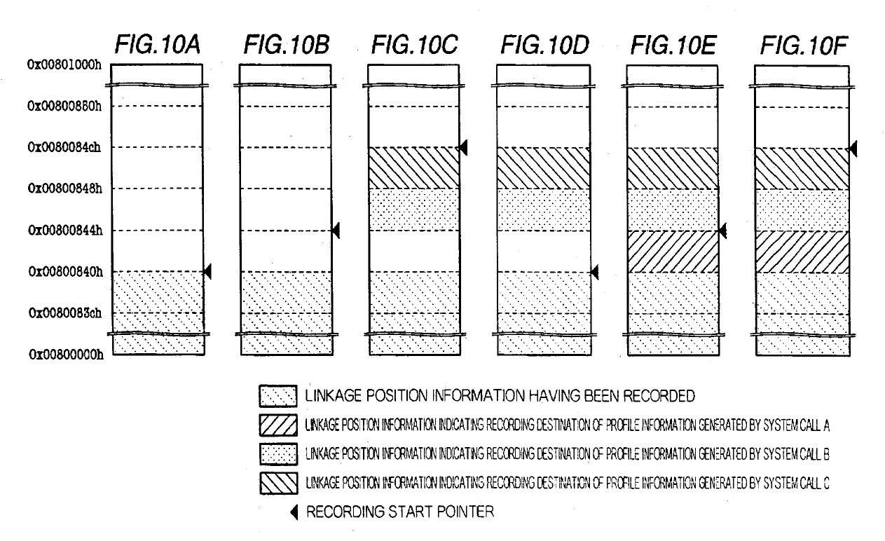

FIGS. 10A-10F show the transition of the recording start pointer when the system call A is executed.

As shown in FIGS. 10A-10F, the profile information storage area 180 ranges from the lowest address 0x00800000h and the uppermost address 0x00801000h. Each piece of linkage position information is recorded in the linkage position information storage area 280 in the order from the lowest address to the uppermost address.

As shown in FIG. 10A, the recording start pointer indicates address 0x00800840h before the system call A is executed.

In step S101, the system call A executes the storage area reserving process.

In step S211, the storage area reserving unit 126 acquires the recording start pointer (0x00800840h) from the linkage position information storage area 280.

In step S212, the storage area reserving unit 226 records the acquired recording start pointer (0x00800840h) in the reserved position information storage area 170 as the reserved position information.

In step S213, the storage area reserving unit 226 shifts the recording start pointer upward by the size of a piece of linkage position information for the second layer profile information.

As shown in FIG. 10B, the recording start pointer indicates address 0x00800844h after the step S213.

In step S102, the system call A executes a function F, and in step S103, executes system call B contained in the first layer software program group 106.

The profile information recording unit 227 acquires a piece of profile information generated for the system call B, records the acquired profile information in the profile information storage area 180, and records a piece of linkage position information indicating the address of the acquired profile information in a storage area ranging from 0x00800844h to 0x00800847h.

In step S104, the system call A executes system call C contained in the first layer software program group 106.

The profile information recording unit 227 acquires a piece of profile information generated for the system call C, records the acquired profile information in the profile information storage area 180, and records a piece of linkage position information indicating the address of the acquired profile information in a storage area ranging from 0x00800848h to 0x0080084bh.

As shown in FIG. 10C, the recording start pointer indicates address 0x0080084ch after the step S104.

In step S105, the system call A executes the profile information recording process.

In step S221, the profile information recording unit 227 acquires the recording start pointer (0x0080084ch) from the linkage position information storage area 280.

In step S222, the profile information recording unit 227 records the acquired recording start pointer (0x0080084ch) in the end position information storage area 160 as the end position information.

In step S223, the profile information recording unit 227 reads a piece of reserved position information from the reserved position information storage area 170.

In step S224, the profile information recording unit 227 moves the recording start pointer to the address (0x00800840h) indicated by the read piece of reserved position information.

In step S225, the profile information recording unit 227 acquires the second layer profile information, and records the acquired second layer profile information in the profile information storage area 180.

In step S226, the profile information recording unit 227 records a piece of linkage position information, which indicates the address of the acquired second layer profile information, in the linkage position information storage area 280 starting with the address (0x00800840h) indicated by the recording start pointer.

As shown in FIG. 10E, the recording start pointer indicates address 0x00800844h after the step S226.

In step S227, the profile information recording unit 227 reads the end position information from the end position information storage area 160.

In step S228, the profile information recording unit 227 moves the recording start pointer to the address (0x0080084ch) indicated by the read end position information.

As shown in FIG. 10F, the recording start pointer indicates address 0x0080084ch after the step S228.

With this, execution of the system call A is completed.

Others for Embodiment 2

The profile information acquisition apparatus 250 may allocate a profile information storage area and a linkage position information storage area in (i) a computer-readable recording apparatus such as a hard disk connected to the profile information acquisition apparatus 250 via the I/O interface 102 or (ii) a computer-readable recording apparatus such as a RAM or a hard disk installed in a general hardware apparatus such as a computer connected to the profile information acquisition apparatus 250 via a network, instead of in the RAM 103, and write the profile information onto the allocated profile information storage area and write the linkage position information onto the allocated linkage position information storage area.

The profile information acquisition apparatus 250, upon receiving a transfer request from the user via the I/O interface 102, may transfer (dump) the profile information, which is recorded in the profile information storage area 180, and the linkage position information, which is recorded in the linkage position information storage area 280, to a transfer destination. Alternatively, the linkage position information recorded in the linkage position information storage area 280 may be automatically transferred when the recorded amount exceeds a predetermined value.

Embodiment 3

Embodiment 3 of the present invention will be described with reference to the drawings. In Embodiment 3, compositions and operations that are used in common with Embodiment 1 are assigned the same reference numbers, and description of them is omitted in Embodiment 3. Also, it is supposed for the sake of convenience that the profile information has a fixed length.

Construction of Profile Information Acquisition System

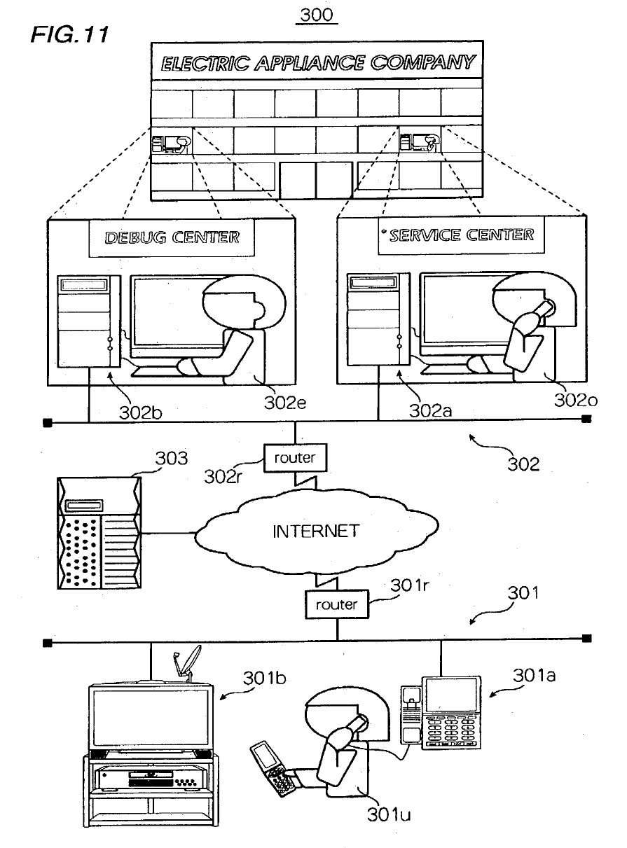

FIG. 11 is a schematic illustration of the profile information acquisition system in Embodiment 3.

As shown in FIG. 11, a profile information acquisition system 300 includes: nodes 301a, 301b, and 301r belonging to a site 301; nodes 302a, 302b, and 302r belonging to a site 302; and a site 303 provided in the Internet. The sites 301 and 302 are connected to each other via the Internet.

The node 301a is an IP (Internet Protocol) phone operated by an actor 301u (hereinafter referred to as a user 301u).

The node 301b is a household electric appliance such as a television or a recording/reproduction apparatus that is an object of a remote maintenance (from which the profile information is acquired).

The nodes 301a and 301b have functions such as UpnP (Universal Plug and Play), “Zeroconf” (Zero Configuration) being developed by TETF (Internet Engineering Task Force), or NDP (Neighbor Discovery Protocol) defined by RFC2461.

The node 301r is a router that is provided between the site 301 and the Internet. The node 301r has functions such as NAPT (Network Address Port Translator), an unsophisticated firewall, UpnP, and a dual stack.

The node 302a is a CTI (Computer Telephony Integration) system operated by an actor 302o (hereinafter referred to as an operator 302o).

The node 302b is a computer system operated by an actor 302e (hereinafter referred to as an engineer) when the engineer performs a remote maintenance of a household electric appliance such as the node 301b.

The node 302r is a router that is provided between the site 302 and the Internet.

The node 303 is an SIP (Session Initiation Protocol) server that functions as an intermediary used when a session is established between the nodes 301a, 301b, 302a, 302b and the like.

The nodes 301a, 301b, and 301r are connected to each other via the network. Similarly, the nodes 302a, 302b, and 302r are connected to each other via the network.

More specifically, the nodes 301a, 301b, 301r, 302a, 302b, and 302r use IEEE (Institute of Electrical and Electronics Engineers) 802.3 (Ethernet), IEEE 802.11a/b/e/g, USB (Universal Serial Bus), IEEE 1394, Bluetooth or the like in the Network Interface Layer, use IPv4 (Internet Protocol version 4) defined by RFC791, ICMPv4 (Internet Control Message Protocol version 4) defined by RFC792, IPv6 (Internet Protocol version 6) defined by RFC2460, ICMPv6 (Internet Control Message Protocol version 6) defined by RFC2463 or the like in the Internet Layer, and use TCP (Transmission Control Protocol) defined by RFC793, UDP (User Datagram Protocol) defined by RFC768 or the like in the Transport Layer.

The node 301b uses a protocol provided by a profile information acquisition agent program in the Application Layer. The node 302b uses a protocol provided by a profile information acquisition management program in the Application Layer.

The node 301a may be a base station having a slave unit that can perform a data communication by IEEE 802.11a/b/e/g or the like. Furthermore, the slave unit may have an interface such as IEEE 802.3, IEEE 802.11a/b/e/g, USB, IEEE 1394, Bluetooth or the like and may establish a connection with a household electric appliance via such an interface.

Hereinafter, the node 301b is referred to as a profile information acquisition agent apparatus 301b, and the node 302b is referred to as a profile information acquisition management apparatus 302b.

The node 301a uses SIP (Session Initiation Protocol) defined by RFC3261 as a call control protocol, uses SDP (Session Description Protocol) defined by RFC2327 as a session description language, and uses RTP (Real-time Transport Protocol) defined by RFC1889 for audio transmission.

The following is a description of a sequence example in which an encryption communication is established between the profile information acquisition agent apparatus 301b and the profile information acquisition management apparatus 302b in the Application Layer.

Sequence for Connection Between Profile Information Acquisition Agent Apparatus 301b and Profile Information Acquisition Management Apparatus 302b

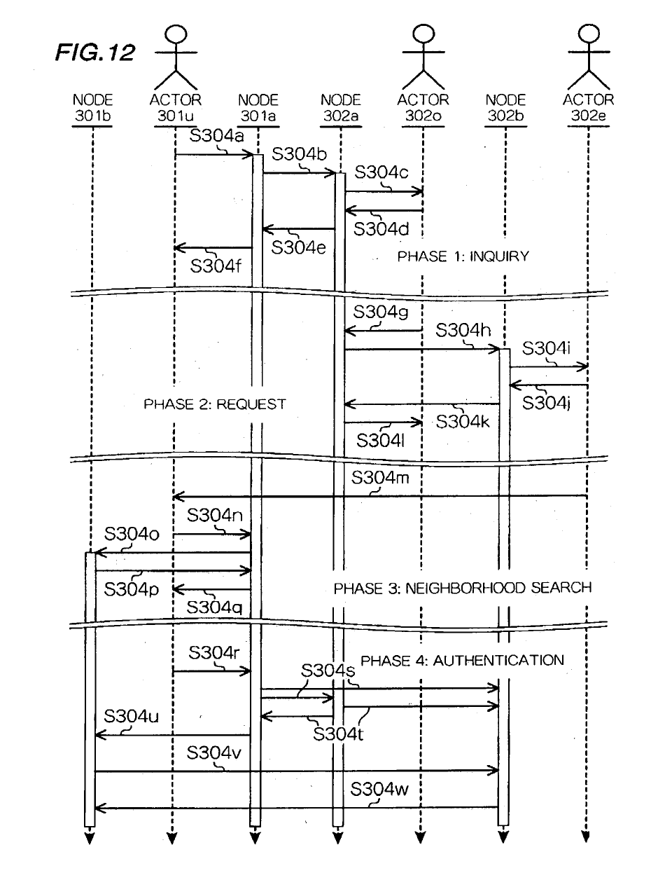

FIG. 12 is a sequence diagram showing establishment of an encryption communication between the profile information acquisition agent apparatus 301b and the profile information acquisition management apparatus 302b in the Application Layer.

As shown in FIG. 12, the profile information acquisition agent apparatus 301b and the profile information acquisition management apparatus 302b pass the phases 1 through 4 before they establishes an encryption communication in the Application Layer.

Phase 1

The actor 301u makes a phone call to a service center of an electric appliance company via the node 301a (sequence S304a).

The node 301a calls the node 302a corresponding to a call destination input from the actor 301u (sequence S304b).

The node 302a, upon receiving the call from the node 301a, notifies the actor 302o of the call (sequence S304c).

The actor 302o picks up the phone via the node 302a (sequence S304d).

The node 302a notifies the node 301a that the actor 302o picked up the phone (sequences S304e and S304f).

After this, the actors 301u and 302o have a conversation via the nodes 301a and 302a.

Phase 2

The actor 302o judges through the conversation with the actor 301a that a remote maintenance is required, and makes a phone call to a debug center of the electric appliance company (sequence S304g).

The node 302a calls the node 302b corresponding to a call destination input from the actor 302o (sequence S304h).

The node 302b, upon receiving the call from the node 302a, notifies the actor 302e of the call (sequence S304i).

The actor 302e picks up the phone via the node 302b (sequence S304j).

The node 302b notifies the node 302a that the actor 302e picked up the phone (sequences S304k and S304l).

After this, the actors 301u, 302o, and 302e have a conversation via the nodes 301a, 302a, and 302b.

Phase 3

The actor 302e is given an explanation for the matter from the actors 301u and 302o, then requests the actor 301u to transmit product information (sequence S304m).

The actor 301u, upon receiving the request from the actor 302e, causes the node 301a to display a list of household electric appliances connected to the site 301 (sequence S304n).

The node 301a performs a neighborhood search (sequences S304o and S304p). The node 301a obtains a list of household electric appliances connected to the site 301 as a result of the neighborhood search, and displays icons representing the household electric appliances in the list on a display screen of the node 301a (IP phone) (sequence S304q).

Phase 4

The actor 301u selects an icon corresponding to the electric appliance among the icons displayed on the screen of the node 301a (sequence S304r).

The node 301a transmits the product information corresponding to the selected electric appliance to the nodes 302a and 302b (sequence S304s).

The node 302a, upon receiving the product information from the node 301a, searches a product information database (not illustrated) using the received product information as a search key, and obtains a product encryption key that has been stored in correspondence with the search key in the product information database.

It should be noted here that a product encryption key makes a pair with a product decryption key that has already been registered in relation to a product.

The node 302a then generates a pair of keys (encryption and decryption keys) for use in an asymmetric key encryption method.

The node 302a further generates reception information that contains the encryption key of the generated key pair (hereinafter, the encryption key is referred to as reception encryption key), a reception number, a destination address or the like.

It should be noted here that the encryption key refers to a key that is used when a plaintext is converted (encrypted) into a ciphertext, and that the decryption key refers to a key that is used when the ciphertext is converted (decrypted) back into the plaintext. Also, the asymmetric key encryption method refers to a method in which two different keys are used in the encryption and decryption, respectively.

The node 302a encrypts the reception information by the asymmetric key encryption method using the obtained product encryption key, and transmits the encrypted reception information to the node 301a.

The node 302a then generates request information that contains the decryption key of the generated key pair (hereinafter, the decryption key is referred to as reception decryption key), the reception number, a destination address or the like.

The node 302a encrypts the request information by the asymmetric key encryption method using the obtained product encryption key, and transmits the encrypted request information to the node 302b (sequence S304t).

The node 301a, upon receiving the encrypted reception information from the node 302a, transfers the received encrypted reception information to the node 301b (sequence S304u).

The node 301b, upon receiving the encrypted reception information from the node 301a, decrypts the encrypted reception information by the asymmetric key encryption method using a production decryption key that has already been registered in relation to the product.

The node 301b then generates a pair of keys (encryption and decryption keys) for use in the asymmetric key encryption method.

The node 301b further generates response information that contains the encryption key of the generated key pair (hereinafter, the encryption key is referred to as agent encryption key), the reception number, a destination address or the like. The node 301b then encrypts the response information by the asymmetric key encryption method using the reception encryption key contained in the reception information that is produced by decrypting the encrypted reception information, and transmits the encrypted response information to the node 302b (response destination) (sequence S304v). It should be noted here that a decryption key used for decrypting data having been encrypted using an agent encryption key is referred to as an agent decryption key.

The node 302b, upon receiving the encrypted request information from the node 302a, searches the product information database using the received product information as a search key, and obtains a product decryption key that has been stored in correspondence with the search key in the product information database. The node 302b then decrypts the encrypted request information by the asymmetric key encryption method using the obtained product decryption key.

The node 302b, upon receiving the encrypted response information from the node 301b, decrypts the encrypted response information by the asymmetric key encryption method using the reception decryption key contained in the request information that is produced by decrypting the encrypted request information.

The node 302b then generates a pair of keys (encryption and decryption keys) for use in the asymmetric key encryption method. The node 302b further generates reply information that contains the encryption key of the generated key pair (hereinafter, the encryption key is referred to as management encryption key) and the reception number. The node 302b then encrypts the reply information by the asymmetric key encryption method using the agent encryption key contained in the response information that is produced by decrypting the encrypted response information, and transmits the encrypted reply information to the node 301b (sequence S304w). It should be noted here that a decryption key used for decrypting data having been encrypted using a management encryption key is referred to as a management decryption key.

The node 301b, upon receiving the encrypted reply information from the node 302b, decrypts the encrypted reply information by the asymmetric key encryption method using the agent decryption key.

It should be noted here that the agent decryption key, which is an encryption key used in the asymmetric key encryption method, may be replaced by an encryption key (also used as a decryption key) used in the symmetric key encryption method. Here, the symmetric key encryption method refers to a method in which the same key (also referred to as a symmetric key) is used as an encryption key and a decryption key in a pair.

This also applies to the management encryption key. The agent encryption key and the management encryption key may be different symmetric keys or the same symmetric key.

In the above description, it is supposed that a data communication is performed between the profile information acquisition agent apparatus 301b and the profile information acquisition management apparatus 302b via a network that has low levels of security, reliability, and integrity, such as the Internet. However, a network that has high levels of security, reliability, and integrity, such as a dedicated line or VPN (Virtual Private Network) may be used. In that case, the above-described authentication operation may be omitted.

The actor 301u may receive an instruction such as “please press xx button for the product on which you want support” from the actor 302o, and press the xx button. Alternatively, the actor 301u may receive an instruction such as “please press xx button after inputting the following alphanumeric characters for the product on which you want support” from the actor 302o, input the alphanumeric characters, and press the xx button. In both cases, the node 301b may receive a connection request, which is issued when the xx button is pressed, from the actor 301u via the I/O interface 102, and establish a connection with the node 302b.

Instead of the alphanumeric characters notified from the actor 302o, the actor 301u may input a product number assigned to the product at the production, a registration number that has been registered with the node 302b in advance, or the like.

The node 301b may hold ID information of the node 301b and an address of the node 302b, and, upon power-up or the like, register the ID information of the node 301b and address of the node 301b with the node 302b by correlating them with each other. Then, the actor 302o, upon receiving a support request from the actor 301u, may issue an instruction such as “please show ID information of the product on which you want support” to the actor 301u, receive the ID information from the actor 301u, and notify the actor 302e of the ID information. The node 302b may identify the address of the node 301b registered with the node 302b, from the notified ID information, and establish a connection with the node 301b using the identified address.

The alphanumeric characters to be notified from the actor 302o are, for example, the address of the node 302b or the reception number that is issued each time the node 301a receives a call.

The address (for example; an IP address or a host name) of the node 302b maybe registered with the node 301b in advance. Alternatively, the actor 301u may input the address of the node 302b when it issues a connection request.

A URI (Uniform Resource Identifier) may be used instead of the address.

Screen Display Example

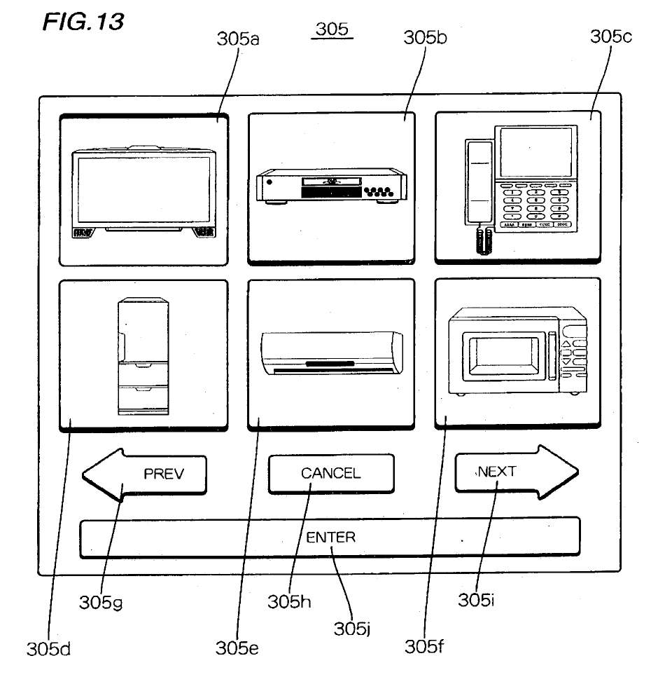

FIG. 13 is a schematic illustration of a list of household electric appliances connected to the network, which is displayed on a screen of an IP phone as a result of a neighborhood search.

In this example, as shown in FIG. 13, icons representing the household electric appliances connected to the site 301 are displayed on a display screen 305 of an IP phone 301a.

In the uppermost row of FIG. 13, from left to right, there are an icon 305a representing a television, an icon 305b representing a recording/reproduction apparatus, and an icon 305c representing an IP phone. Similarly, in the middle row, from left to right, there are an icon 305d representing a refrigerator, an icon 305e representing an air conditioner, and an icon 305f representing a microwave. In the lowest row, there are a previous key 305g used to display a previous list of icons, a next key 305i used to display a next list of icons, a cancel key 305h used to cancel a selection of an icon, and an enter key 305j used to confirm a selection of an icon.

The icons 305a-305f are respectively corresponded to keys “1” to “6” of the ten key pad provided on the IP phone 301a. Also, the previous key 305g, cancel key 305h, next key 305i, and enter key 305j are respectively corresponded to keys “7”, “8”, “9”, and “0” of the ten key pad provided on the IF phone 301a. With this construction, if the key “1”, and then key “0” is pressed, the television represented by the icon 305a is selected. In this example, when such operations are made, the product information obtained by the neighborhood search in relation to the television is transmitted to the nodes 302a and 302b.

After an encryption communication is established in the Application Layer with the above-described sequence, data is transferred between the profile information acquisition agent apparatus 301b and the profile information acquisition management apparatus 302b. Accordingly, description of the other components of the profile information acquisition system 300 is omitted here.

The following is a description of the construction and operation of the profile information acquisition agent apparatus 301b and the profile information acquisition management apparatus 302b.

Construction of Profile Information Acquisition Agent Apparatus 301b and Profile Information Acquisition Management Apparatus 302b

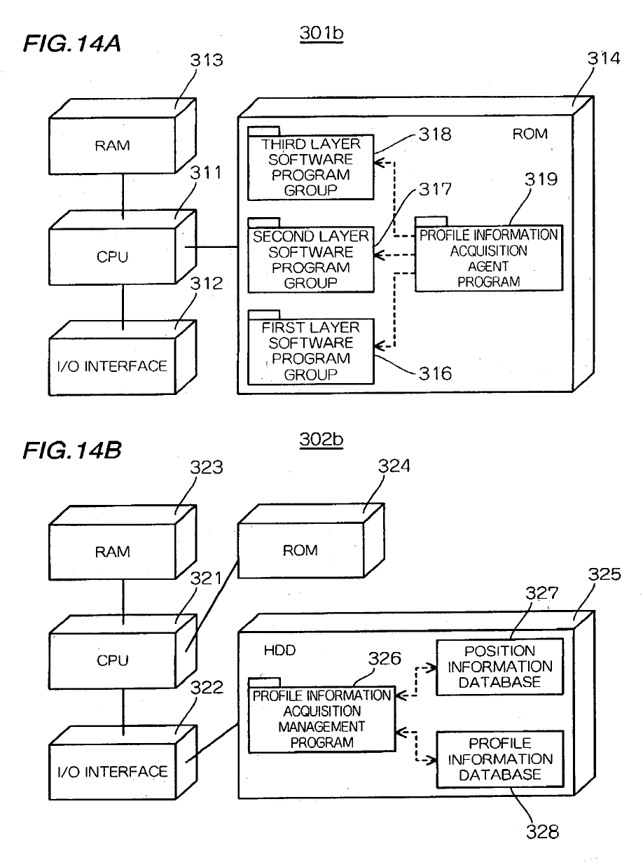

FIG. 14A is a deployment diagram showing the internal construction of the profile information acquisition agent apparatus 301b. FIG. 14B is a deployment diagram showing the internal construction of the profile information acquisition management apparatus 302b.

As shown in FIG. 14A, the profile information acquisition agent apparatus 301b includes a CPU 311, an I/O interface 312, a RAM 313, and a ROM 314.

The CPU (Central Processing Unit) 311 processes a software program stored in the ROM 314.

The I/O interface 312 inputs and outputs data to/from peripheral devices (not illustrated) connected to the profile information acquisition agent apparatus 301b. The I/O interface 312 is achieved by, for example, an infrared communication port, Bluetooth, USB, IEEE1394, or a network interface card.

The RAM 313 is a semiconductor memory such as DRAM or SRAM from/to which data is read or written as the need arises.

The ROM (Read-Only Memory) 314 is a memory such as a mask ROM, PROM, or EPROM that allows only data reading from it.

The ROM 314 includes a first layer software program group 316, a second layer software program group 317, and a third layer software program group 318, and a profile information acquisition agent program 319.

The first layer software program group 316 differs from the first layer software program group 106 in that it does not contain the first layer profile information acquisition program 110.

The second layer software program group 317 differs from the second layer software program group 107 in that it does not contain the second layer profile information acquisition program 120.

The third layer software program group 318 differs from the third layer software program group 108 in that it does not contain the third layer profile information acquisition program 130.

The profile information acquisition agent program 319 includes the first layer profile information acquisition program 110, second layer profile information acquisition program 120, and third layer profile information acquisition program 130.

The profile information acquisition agent apparatus 301b is achieved in terms of its function as the CPU 319 executes the profile information acquisition agent program 319.

As shown in FIG. 14B, the profile information acquisition management apparatus 302b includes a CPU 321, an I/O interface 322, a RAM 323, a ROM 324, and a HDD 325.

The CPU (Central Processing Unit) 321 processes software programs stored in the ROM 324 and the HDD 325.

The I/O interface 322 inputs and outputs data to/from peripheral devices (not illustrated) connected to the profile information acquisition management apparatus 302b. The I/O interface 312 is achieved by, for example, an infrared communication port, Bluetooth, USB, 1EEE1394, or a network interface card.

The RAM 323 is a semiconductor memory such as DRAM or SRAM from/to which data is read or written as the need arises.

The ROM (Read-Only Memory) 324 is a memory such as a mask ROM, PROM, or EPROM that allows only data reading from it.

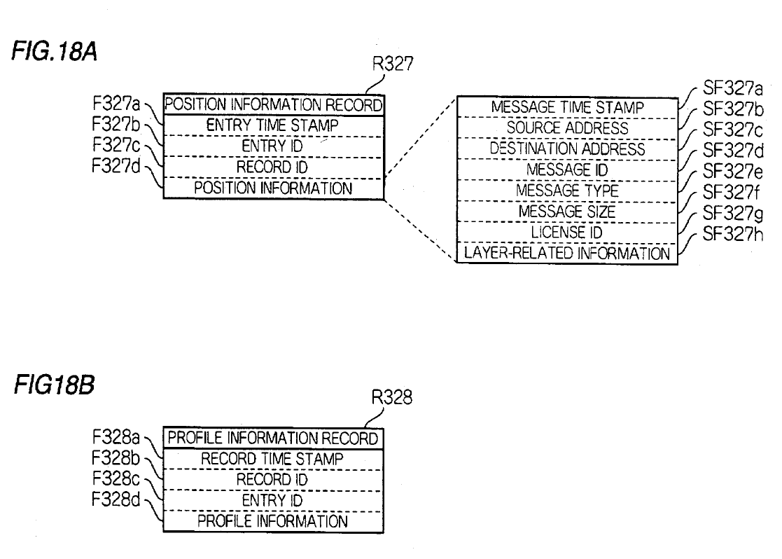

The HDD 325 is a magnetic recording medium from/to which data is read or written as the need arises. The HDD 325 includes a profile information acquisition management program 326, a position information database 327, and a profile information database 328. The position information database 327 and the profile information database 328 will be described later with reference to FIG. 18.

The profile information acquisition management apparatus 302b is achieved in terms of its function as the CPU 321 executes the profile information acquisition management program 326.

State Transition in Profile Information Acquisition Agent Apparatus

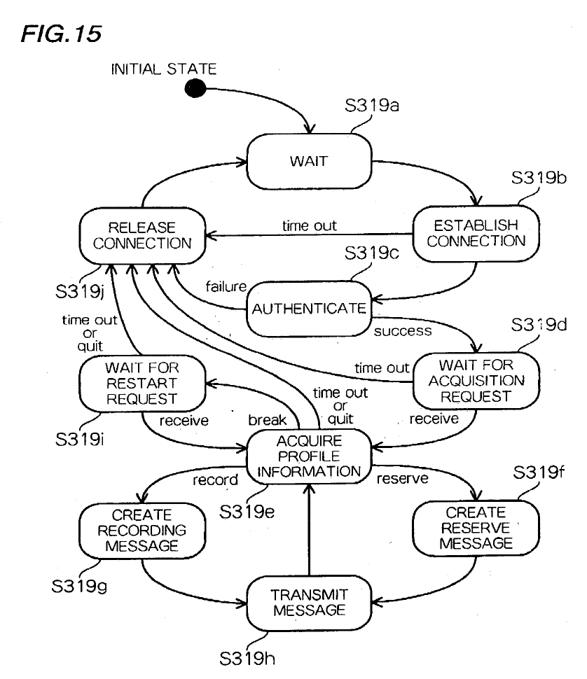

FIG. 15 is a state chart showing the state transition in the profile information acquisition agent apparatus.

As shown in FIG. 15, the state of the profile information acquisition agent apparatus changes as follows.

The CPU 311 executes the profile information acquisition agent program 319 that has been read from the ROM 313 and stored in the RAM 313, and boots the profile information acquisition agent apparatus (initial state). The profile information acquisition agent apparatus waits until a connection process is generated (state S319a); if the connection process is generated, establishes the TCP connection (state S319b); performs an authentication (key exchange) with the connection partner (state S319c); if the authentication is successful, waits until it receives an acquisition request from the connection partner (state S319d); and upon receiving the acquisition request, executes a profile information acquisition process (state S319e).

It should be noted here that the profile information acquisition process refers to a process in which a target software program is executed, and the profile information generated by the program is acquired.

If the profile information acquisition agent apparatus receives a suspend request while executing the profile information acquisition process, it suspends the process and waits until it receives a restart request from the connection partner (state s319i); if it does not receive a restart request within a certain time period, or if it receives a termination request, it releases the TCP connection (state S319j); and waits until a connection process is generated (state S319a) If the profile information acquisition agent apparatus receives a restart request from the connection partner, it restarts the profile information acquisition process (state S319e).

The profile information acquisition agent apparatus also releases the TCP connection (state S319j) and waits until a connection process is generated (state S319a) if any of the following happens: a connection is not established within a certain time period in the state S319b; the authentication (key exchange) with the connection partner in the state S319c is unsuccessful; it does not receive an acquisition request within a certain time period in the state S319d; it does not receive the profile information within a certain time period in the state S319e; or it receives a termination request in the state S319e.

If the profile information acquisition agent apparatus finds in the state S319e that it is necessary to reserve a storage area for recording the profile information to be acquired, it creates a reserve message (state S319f), and transmits the created reserve message to the connection partner (state S319h) If the profile information acquisition agent apparatus finds in the state S319e that it should record the acquired profile information into a storage area, it creates a record message (state S319g), and transmits the created record message to the connection partner (state S319h). After the state S319h, the profile information acquisition agent apparatus returns to the state S319e to execute the profile information acquisition process.

Now, the state transition in the profile information acquisition management apparatus will be described.

State Transition in Profile Information Acquisition Management Apparatus

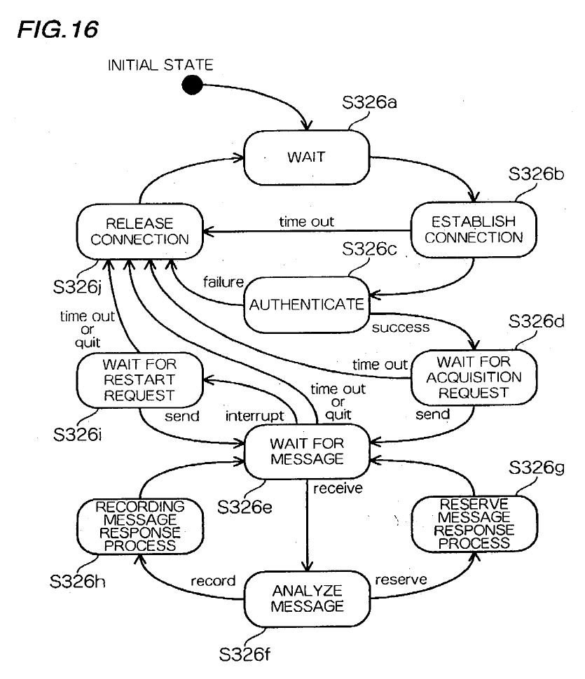

FIG. 16 is a state chart showing the state transition in the profile information acquisition management apparatus.

As shown in FIG. 16, the state of the profile information acquisition management apparatus changes as follows.

The CPU 321 executes the profile information acquisition management program 326 that has been read from the HDD 325 and stored in the RAM 323 via the I/O interface 322, and boots the profile information acquisition management apparatus (initial state). The profile information acquisition management apparatus waits until a connection process is generated (state S326a); if the connection process is generated, establishes the TCP connection (state S326b); performs an authentication (key exchange) with the connection partner (state S326c); if the authentication is successful, waits until it receives an acquisition request from the engineer 302e (state S326d); and upon receiving the acquisition request, transmits the received acquisition request to the connection partner, and waits until it receives a message from the connection partner (state S326e).

If the profile information acquisition management apparatus receives an interrupt request from the engineer 302e while it is waiting for a message, it waits until it receives a restart request (state s326i); if it does not receive a restart request within a certain time period, or if it receives a termination request, it releases the TCP connection (state S326j); and waits until a connection process is generated (state S326a). If the profile information acquisition management apparatus receives a restart request from the engineer 302e, it transmits the received restart request to the connection partner and waits until it receives a message from the connection partner (state S326e).

The profile information acquisition management apparatus also releases the TCP connection (state S326j) and waits until a connection process is generated (state S326a) if any of the following happens: a connection is not established within a certain time period in the state S326b; the authentication (key exchange) with the connection partner in the state 326c is unsuccessful; it does not receive an acquisition request within a certain time period in the state S326d; it does not receive a message within a certain time period in the state S326e; or it receives a termination request in the state S326e.

If the profile information acquisition management apparatus receives a message from the connection partner in the state S326e, it analyzes the received message (state S326f), and if the received message is found to be a reserve message, it executes a reserve message response process (state S326g), and if the received message is found to be a record message, it executes a record message response process (state S326h), and then waits until it receives a message from the connection partner (state S326e).

Now, the data structures of the reserve and record messages, which are transferred between the profile information acquisition management apparatus 301b and the profile information acquisition management apparatus 302b, will be described.

Data Structures of Reserve and Record Messages

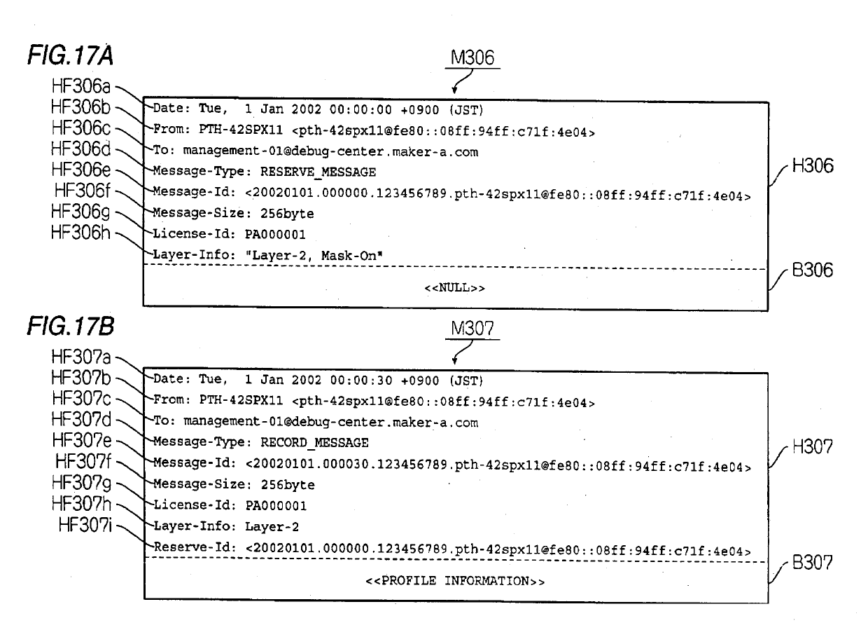

FIG. 17A shows the data structure of the reserve message. FIG. 17B shows the data structure of the record message.

As shown in FIG. 17A, a reserve message M306 is composed of a header H306 and a body B306.

The header H306 is composed of header fields HF306a-HF306h. Each of the header fields HF306a-HF306h has a field name and a field body which are separated by a colon (:).

The header field HF306a is composed of: a field name that indicates a Date field; and a field body that indicates a date on which the message was created (the date is hereinafter referred to as a message time stamp).

The header field HF306b is composed of: a field name that indicates a From field; and a field body that indicates a message transmission source (hereinafter referred to as a source address).

The header field HF306c is composed of: a field name that indicates a To field; and a field body that indicates a message transmission destination (hereinafter referred to as a destination address).

The header field HF306d is composed of: a field name that indicates a Message-Type field; and a field body that indicates the type of a created message (hereinafter referred to as a message type).

The message types are, for example, “RESERVE_MESSAGE” and “RECORD_MESSAGE”.

The header field HF306e is composed of: a field name that indicates a Message-Id field; and a field body that indicates ID information that is generated uniquely for each message and increases in time series (hereinafter referred to as a message ID).

The header field HF306f is composed of: a field name that indicates a Message-Size field; and a field body that indicates a message size.

The header field HF306g is composed of: a field name that indicates a License-Id field; and a field body that indicates an ID number which is assigned uniquely to a maker, business operation, organization, group or the like (hereinafter referred to as a license ID).

The header field HF306h is composed of: a field name that indicates a Layer-Info field; and a field body that indicates information related to a layer to which the message belongs (hereinafter referred to as layer-related information).

The body B306 is NULL.

As shown in FIG. 17B, a record message M307 is composed of a header H307 and a body B307.

The header H307 is composed of header fields HF307a-HF307i. Each of the header fields HF307a-HF307i has a field name and a field body which are separated by a colon (:). The header fields HF307a-HF307h are the same as the header fields HF306a-HF306h, and the description thereof is omitted here.

The header field HF307i is composed of: a field name that indicates a Reserve-Id field; and a field body that indicates a message ID that is assigned to a reserve message for reserving a storage area (hereinafter referred to as a reserve ID).

The body B307 includes the profile information.

The header H307 and body B307 in the record message M307 are separated from each other by a blank line.

It is supposed that the messages are constructed by the RFC2822 format, except where specifically noted.

The messages may have the tag construction used in XML (extensible Markup Language) or the like defined by W3C (World Wide Web Consortium).

Now, the data structures of the position information record and the profile information record, which are respectively stored in the position information database 327 and the profile information database 328, will be described.

Data Structures of Position Information Record and Profile Information Record

FIG. 18A shows the data structure of the position information record which is stored in the position information database. FIG. 18B shows the data structures of the profile information record which is stored in the profile information database.

As shown in FIG. 18A, a position information record R327 is composed of fields F327a-F327d.

The field F327a stores information of a date on which an entry ID was created (hereinafter referred to as an entry time stamp).

The entry ID indicates ID information that is generated uniquely for each piece of point information registered with the point information database 327 and increases in time series.

The field F327b stores entry IDs.

The field F327c stores record IDs.

The record ID indicates ID information that is generated uniquely for each piece of profile information recorded in the profile information database 328 and increases in time series.

The field F327d stores the position information.

The position information (field F327d) is composed of sub-fields SF327a-SF327h.

The sub-field SF327a stores the field body (message time stamp) of the header field HF306a.

The sub-field SF327b stores the field body (source address) of the header field HF306b.

The sub-field SF327c stores the field body (destination address) of the header field HF306c.

The sub-field SF327d stores the field body (message type) of the header field HF306d.

The sub-field SF327e stores the field body (message ID) of the header field HF306e.

The sub-field SF327f stores the field body (message size) of the header field HF306f.

The sub-field SF327g stores the field body (license ID) of the header field HF306g.

The sub-field SF327h stores the field body (layer-related information) of the header field HF306h.

As shown in FIG. 18B, a profile information record R328 is composed of fields F328a-F328d.

The field F328a stores information of a date on which a record ID was created (hereinafter referred to as a record time stamp).

The field F328b stores record IDs.

The field F328c stores entry IDs.

The field F328d stores the profile information.

It should be noted here that the entry IDs and record IDs are positive values.

Now, the construction of the profile information acquisition agent apparatus 301b when the profile information acquisition agent program 319 is executed will be described.

Construction of Profile Information Acquisition Agent Apparatus

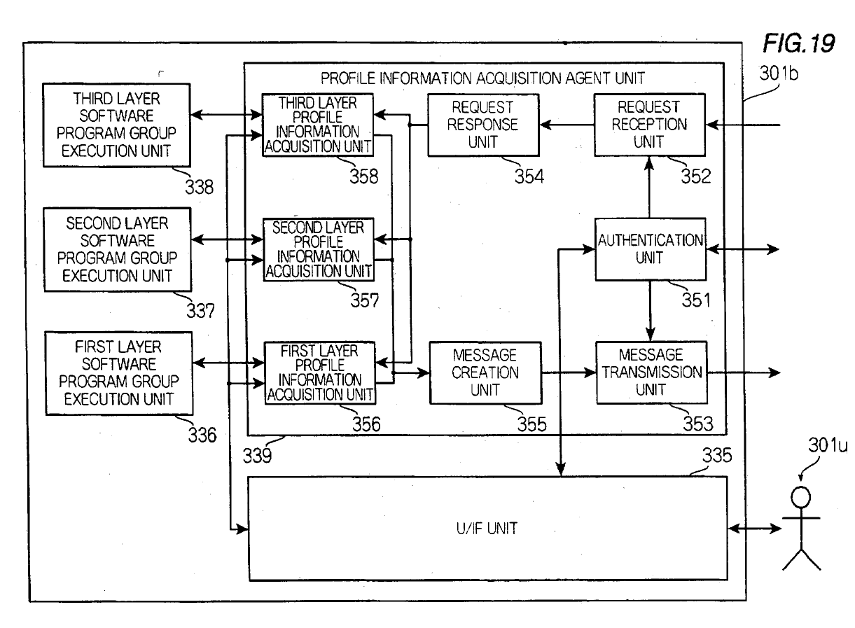

FIG. 19 is a functional block diagram showing the construction of the profile information acquisition agent apparatus when the profile information acquisition agent program is executed.

As shown in FIG. 19, the profile information acquisition agent apparatus 301b is composed of a U/IF unit 335, a first layer software program group execution unit 336, a second layer software program group execution unit 337, a third layer software program group execution unit 338, and a profile information acquisition agent unit 339.

The first layer software program group execution unit 336, second layer software program group execution unit 337, and third layer software program group execution unit 338 have the same components and operate in the same way. Here, only the second layer software program group execution unit 337 will be described as a representative.

The U/IF unit 335 connects the user 301u with the profile information acquisition agent apparatus 301b, and is, for example, a remote controller that is connected via the I/O interface 312.

The second layer software program group execution unit 337 is a function achieved when a second layer program that belongs to the second layer software program group 317 is read onto the RAM 314 and executed by the CPU 311. As the second layer program is executed, the second layer profile information is generated, and the generated second layer profile information is acquired. This also applies to the first layer software program group execution unit 336 and third layer software program group execution unit 338.

The profile information acquisition agent unit 339 is a function achieved when a profile information acquisition agent program is read onto the RAM 314 and executed by the CPU 311. The profile information acquisition agent unit 339 is composed of an authentication unit 351, a request reception unit 352, a message transmission unit 353, a request response unit 354, a message creation unit 355, a first layer profile information acquisition unit 356, a second layer profile information acquisition unit 357, and a third layer profile information acquisition unit 358.

The first layer profile information acquisition unit 356, second layer profile information acquisition unit 357, and third layer profile information acquisition unit 358 have the same components and operate in the same way. Here, only the second layer profile information acquisition unit 357 will be described as a representative.

The first layer profile information acquisition unit 356, second layer profile information acquisition unit 357, and third layer profile information acquisition unit 358 are functions achieved when the first layer profile information acquisition program, second layer profile information acquisition program, and third layer profile information acquisition program contained in the profile information acquisition agent program 319 are executed.

The authentication unit 351 performs an authentication process (key exchange) when establishing a connection with the profile information acquisition management apparatus 302b, and if the connection is established, passes a management encryption key to the message transmission unit 353, and passes an agent decryption key to the request reception unit 352.

The request reception unit 352, upon receiving an encrypted request from the profile information acquisition management apparatus 302b, if it has received an agent decryption key from the authentication unit 351, decrypts the received encrypted request using the agent decryption key. The request reception unit 352 then passes the request obtained by decrypting the encrypted request to the request response unit 354.

The message transmission unit 353, upon receiving a message from the message creation unit 355, if it has received a management encryption key from the authentication unit 351, encrypts the received message using the management encryption key. The message transmission unit 353 then transmits the encrypted message to the profile information acquisition management apparatus 302b.

The request response unit 354, upon receiving a request from the request reception unit 352, analyzes the received request, and if the received request is an acquisition request, issues an acquisition command to each of the first layer profile information acquisition unit 356, second layer profile information acquisition unit 357, and third layer profile information acquisition unit 358; and if the received request is a suspend request, issues a suspend command, and if the received request is a restart request, issues a restart command.

The message creation unit 355, upon receiving a command from any of the first layer profile information acquisition unit 356, second layer profile information acquisition unit 357, and third layer profile information acquisition unit 358, analyzes the received command, and if the received command is a reserve command, creates a reserve message, and if the received command is a record command, creates a record message, and passes the created message to the message transmission unit 353.

The second layer profile information acquisition unit 357 differs from the second layer profile information acquisition unit 125 in that it, upon receiving an acquisition command from the request response unit 354, causes the second layer software program group execution unit 337 to execute the profile information acquisition process to acquire the second layer profile information, that if it receives a suspend command, it suspends a currently executed profile information acquisition process, that if it receives a restart command, it restarts a currently suspended profile information acquisition process, and that if it receives the profile information from the second layer profile information acquisition unit 357, it passes the received profile information and a record command to the message creation unit 355.

This also applies to the first layer profile information acquisition unit 356 and third layer profile information acquisition unit 358.

Now, the construction of the profile information acquisition management apparatus 302b when the profile information acquisition management program 326 is executed will be described.

Construction of Profile Information Acquisition Management Apparatus

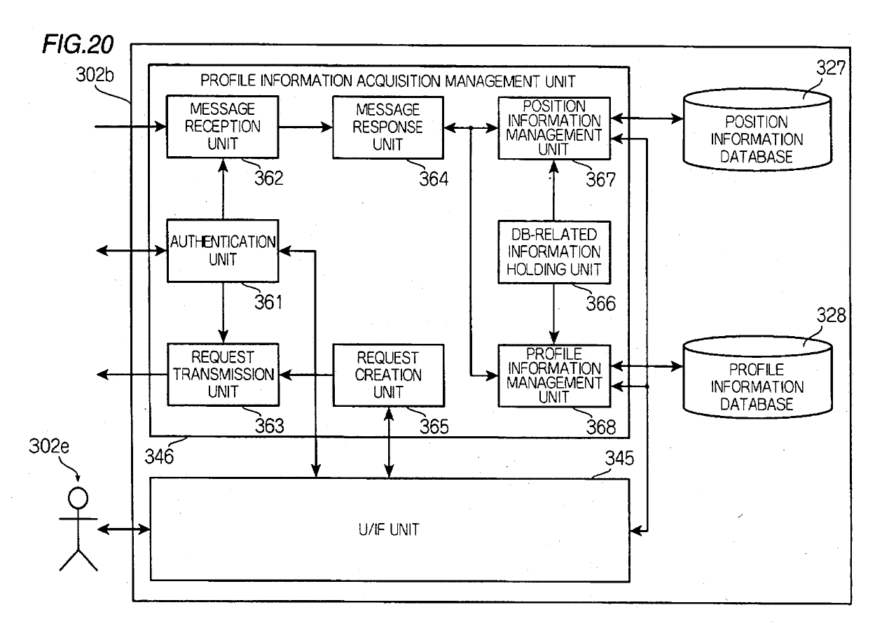

FIG. 20 is a functional block diagram showing the construction of the profile information acquisition management apparatus when the profile information acquisition management program is executed.

As shown in FIG. 20, the profile information acquisition management apparatus 302b is composed of a position information database 327, a profile information database 328, a U/IF unit 345, and a profile information acquisition management unit 346.

The U/IF unit 345 connects the engineer 302e with the profile information acquisition management apparatus 302b, and is, for example, a keyboard, a mouse, or a display connected via the I/O interface 322.

The profile information acquisition management unit 346 is a function achieved when a profile information acquisition management program is read onto the RAM 324 and executed by the CPU 321. The profile information acquisition management unit 346 is composed of an authentication unit 361, a message reception unit 362, a request transmission unit 363, a message response unit 364, a request creation unit 365, a DB-related information holding unit 366, a position information management unit 367, and a profile information management unit 368.

The authentication unit 361 performs an authentication process (key exchange) when establishing a connection with the profile information acquisition agent apparatus 301b, and if the connection is established, passes an agent encryption key to the request transmission unit 363, and passes a management decryption key to the message reception unit 362.

The message reception unit 362, upon receiving an encrypted message from the profile information acquisition agent apparatus 301b, if it has received a management decryption key from the authentication unit 361, decrypts the received encrypted message using the management decryption key. The message reception unit 362 then passes the message obtained by decrypting the encrypted message to the message response unit 364.

The request transmission unit 363, upon receiving a request from the request creation unit 365, if it has received an agent encryption key from the authentication unit 361, encrypts the received request using the agent encryption key. The request transmission unit 363 then transmits the encrypted request to the profile information acquisition agent apparatus 301b.

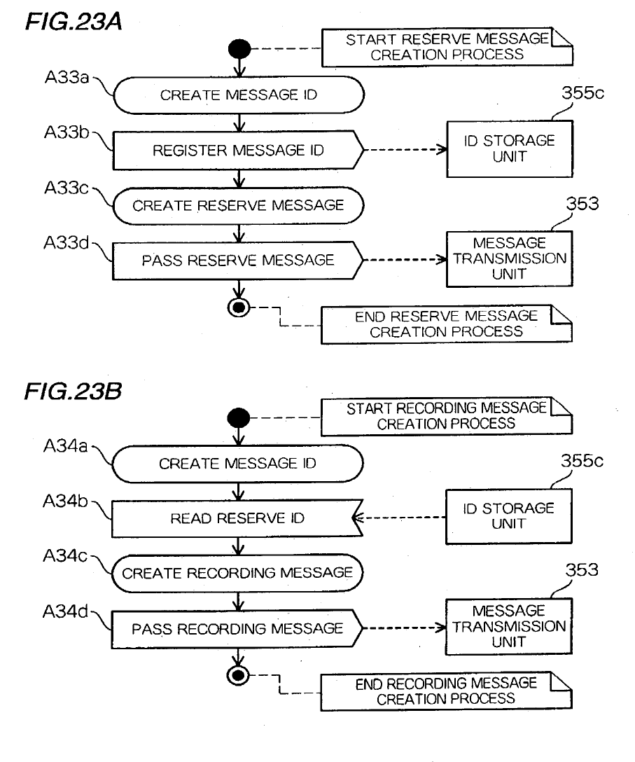

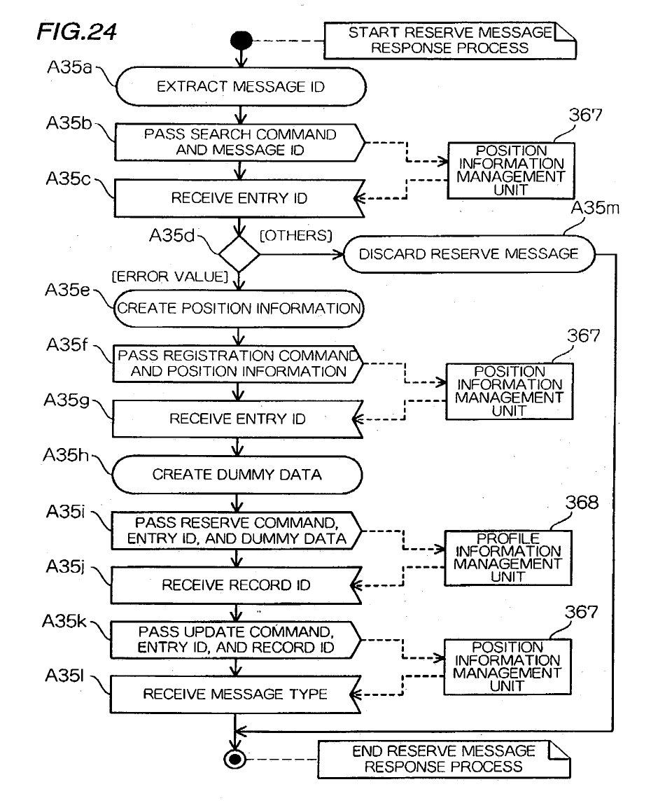

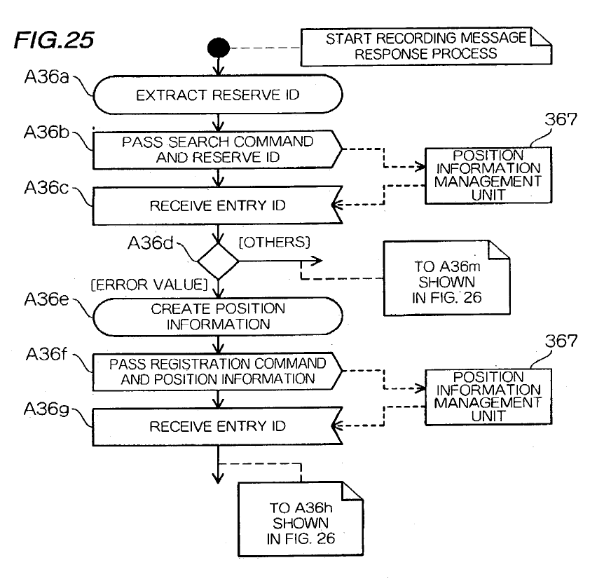

The message response unit 364, upon receiving a message from the message reception unit 362, analyzes the received message, and if the received message is a reserve request, executes a reserve message response process, and if the received message is a record message, executes a record message response process. The reserve message response process will be described later with reference to FIGS. 23 and 24. The record message response process will be described later with reference to FIG. 25.

The request creation unit 365 receives an acquisition request, a suspend request, a restart request or the like from the engineer 302e via the U/IF unit 345, and passes the received request to the request transmission unit 363.

The DB-related information holding unit 366 holds: an address of an area in the position information database 327 where the position information is stored (for example, a host name or an IP address); an address of an area in the profile information database 328 where the profile information is stored (for example, a host name or an IP address); or the like.

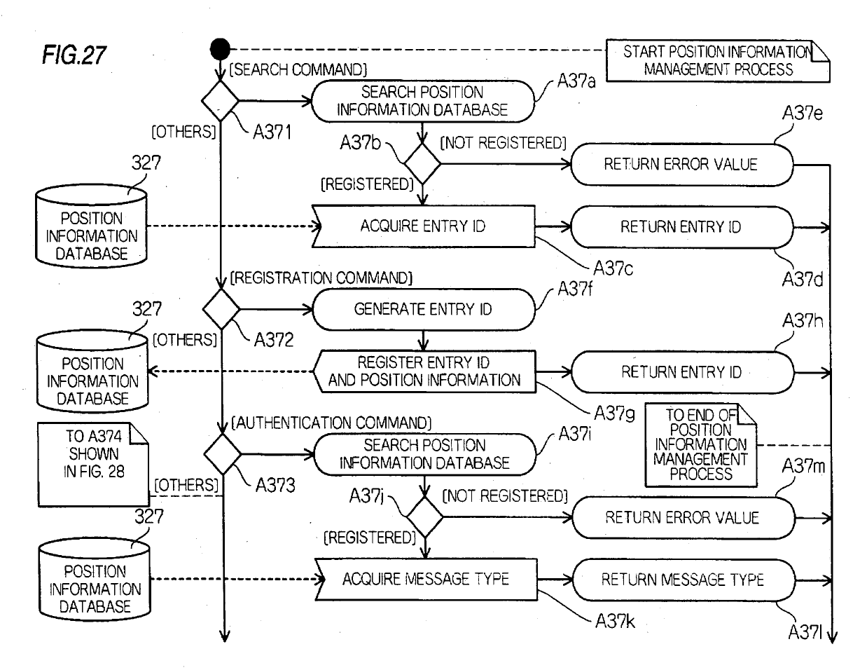

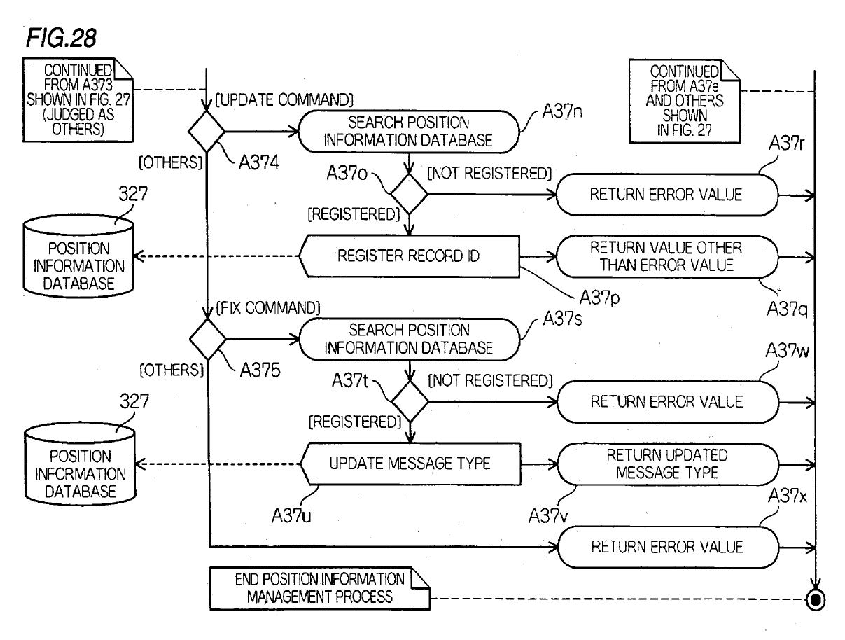

The position information management unit 367, upon receiving a command from the message response unit 364, executes a position information management process for managing the position information database 327, according to the received command. The position information management process will be described later with reference to FIGS. 27 and 28.

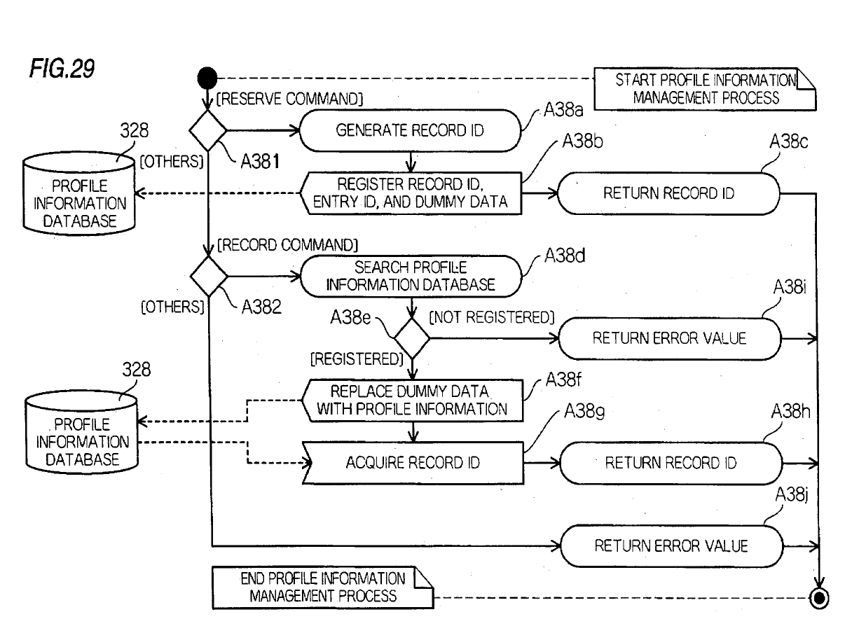

The profile information management unit 368, upon receiving a command from the message response unit 364, executes a profile information management process for managing the position information database 328, according to the received command. The profile information management process will be described later with reference to FIG. 29.

Now, detailed constructions of the profile information acquisition agent apparatus 301b and the profile information acquisition management apparatus 302b will be described centering on creating a message and responding to the created message.

Detailed Constructions of Profile Information Acquisition Agent Apparatus and Profile Information Acquisition Management Apparatus

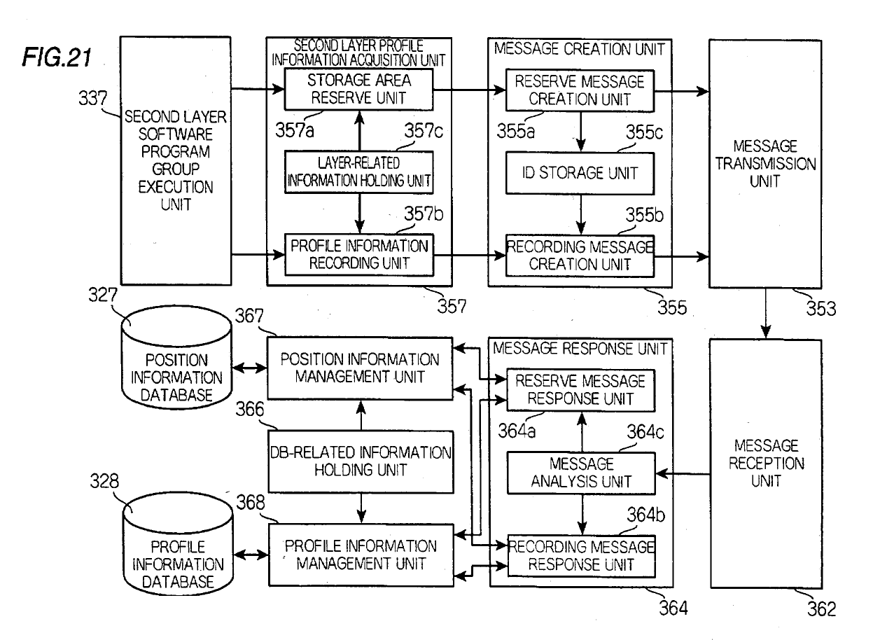

FIG. 21 shows partial constructions of the profile information acquisition agent apparatus 301b and the profile information acquisition management apparatus 302b.

As shown in FIG. 21, the second layer profile information acquisition unit 357 further includes a storage area reserve unit 357a, a profile information recording unit 357b, and a layer-related information holding unit 357c.

The storage area reserve unit 357a, after being called by the second layer software program group execution unit 337 and receiving a size and license ID of the profile information, passes the received size and license ID of the profile information and layer-related information held by the layer-related information holding unit 357c to a reserve message creation unit 355a.

The profile information recording unit 357b, after being called by the second layer software program group execution unit 337 and receiving second layer profile information and a license ID, passes the received second layer profile information and license ID and layer-related information held by the layer-related information holding unit 357c to a record message creation unit 355b.

The layer-related information holding unit 357c holds layer-related information related to the second layer.

The layer-related information includes layer ID information indicating a related layer, a record-destination address (for example, a host name or an IP address) being an address of an area in which the profile information is to be stored, and a mask flag indicating whether to mask a storage area that is reserved for storing the profile information.

The layer-related information to be held by the layer-related information holding unit for each layer may be transmitted from the profile information acquisition management apparatus 302b thereto together with an acquisition request. Alternatively, the layer-related information may be held by the layer-related information holding unit in advance.

The message creation unit 355 further includes a reserve message creation unit 355a, a record message creation unit 355b, and an ID storage unit 355c.

The reserve message creation unit 355a receives the size and license ID of the profile information and layer-related information from the storage area reserve unit 357a, and executes a reserve message creation process. The reserve message creation process will be described in detail later with reference to FIG. 23A.

The record message creation unit 355b receives the profile information and license ID and layer-related information from the profile information recording unit 357b, and executes a record message creation process. The record message creation process will be described in detail later with reference to FIG. 23B.

The ID storage unit 355c stores message IDs by the First-In-Last-Out method. Hereinafter, the message IDs stored in the ID storage unit 355c are referred to as reserve IDs, for the purpose of distinction.

The message response unit 364 further includes a reserve message response unit 364a, a record message response unit 364b, and a message analysis unit 364c.

The reserve message response unit 364a receives a message from the message analysis unit 364c, and executes a reserve message response process. The reserve message response process will be described in detail later with reference to FIG. 24.

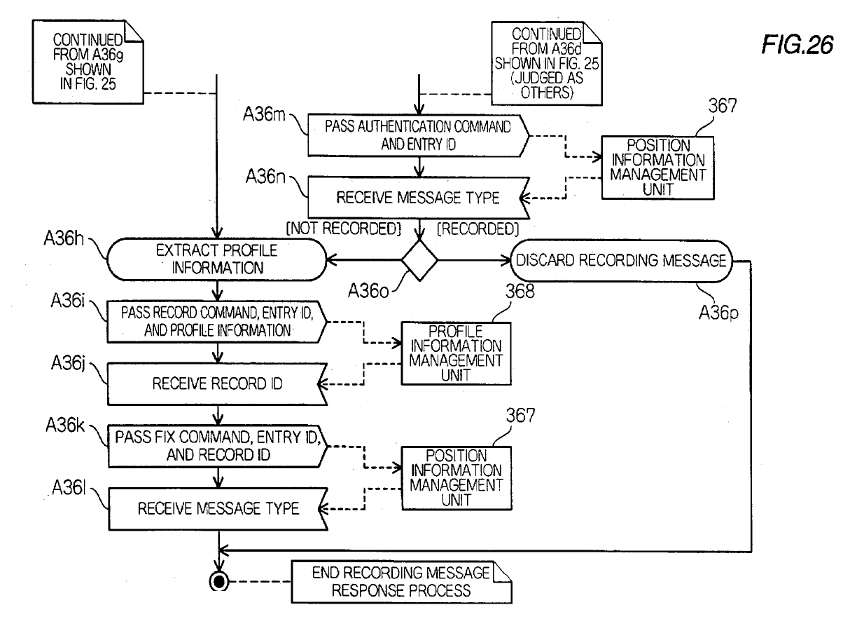

The record message response unit 364b receives a message from the message analysis unit 364c, and executes a record message response process. The record message response process will be described in detail later with reference to FIGS. 25 and 26.

The message analysis unit 364c receives a message from the message reception unit and analyzes the message. If the analysis results show that the received message is a reserve message, the message analysis unit 364c passes the message to the reserve message response unit 364a. If the analysis results show that the received message is a record message, the message analysis unit 364c passes the message to the record message response unit 364b.

Operation of Profile Information Acquisition Agent Apparatus and Profile Information Acquisition Management Apparatus

The following is a description of the operation of the profile information acquisition agent apparatus 301b and the profile information acquisition management apparatus 302b having the above-described constructions. In this description, the system call A shown in Embodiment 1 will be used as an example.

Operation of Profile Information Acquisition Agent Apparatus

The operation of the profile information acquisition agent apparatus 301b will be described first, centering on creating a message to be sent to the profile information acquisition management apparatus 302b.

Storage Area Reserve Process and Profile Information Recording Process

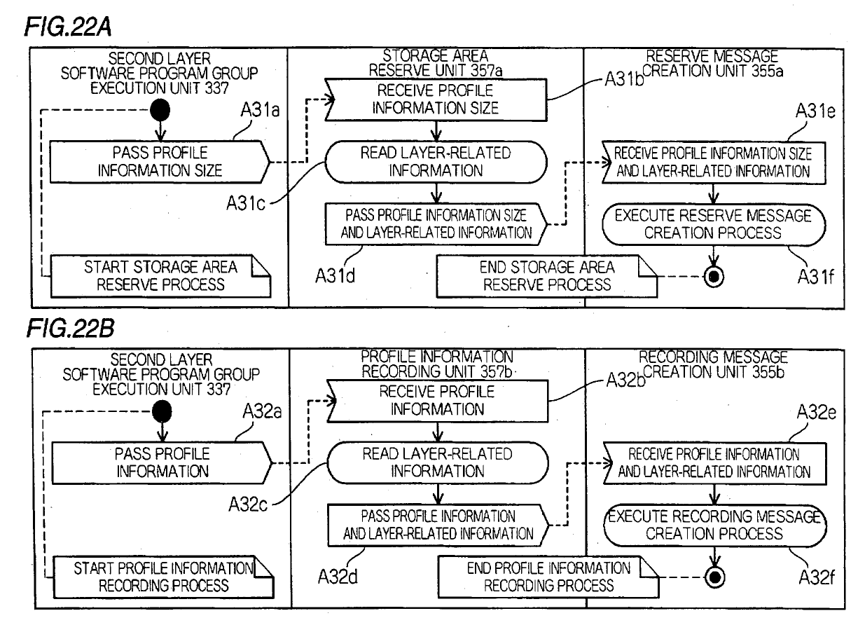

FIG. 22A is an activity diagram showing the storage area reserve process. FIG. 22B an activity diagram showing the profile information recording process.

Storage Area Reserve Process

The process will be described with reference to FIG. 22A. The second layer software program group execution unit 337 passes (i) a size of the second layer profile information that is generated by executing the second layer program and (ii) a license ID contained in the second layer program to the storage area reserve unit 357a (activity A31a).

The storage area reserve unit 357a receives the size of the second layer profile information and the license ID from the second layer software program group execution unit 337 (activity A31b), reads the layer-related information from the layer-related information holding unit 357c (activity A31c), and passes the received size of the second layer profile information and the license ID and the read layer-related information to the reserve message creation unit 355a (activity A31d).

The reserve message creation unit 355a receives the size of the second layer profile information, license ID and layer-related information from the storage area reserve unit 357a (activity A31e), and executes the reserve message creation process (activity A31f).

Profile Information Recording Process

The process will be described with reference to FIG. 22B. The second layer software program group execution unit 337 passes (i) the second layer profile information that is generated by executing the second layer program and (ii) a license ID contained in the second layer program to the profile information recording unit 357b (activity A32a).

The profile information recording unit 357b receives the second layer profile information and the license ID from the second layer software program group execution unit 337 (activity A32b), reads the layer-related information from the layer-related information holding unit 357c (activity A32c), and passes the received second layer profile information and license ID and the read layer-related information to the record message creation unit 355b (activity A32d).

The record message creation unit 355b receives the second layer profile information, license ID and layer-related information from the profile information recording unit 357b (activity A32e) and executes the record message creation process (activity A32f).

Reserve Message Creation Process and Record Message Creation Process

FIG. 23A is an activity diagram showing the reserve message creation process. FIG. 23B is an activity diagram showing the record message creation process.

Reserve Message Creation Process

The process will be described with reference to FIG. 23A. The reserve message creation unit 355a, upon receiving the size of the profile information, license ID and layer-related information from the storage area reserve unit 357a, generates a message ID (activity A33a), registers the generated message ID with the ID storage unit 355c as the reserve ID (activity A33b), creates a reserve message from the received size of the profile information, license ID and layer-related information and the generated message ID (activity A33c), passes the created reserve message to the message transmission unit 353 (activity A33d), and ends the reserve message creation process.

Record Message Creation Process

The process will be described with reference to FIG. 23B. The record message creation unit 355b generates a message ID (activity A34a), reads a reserve ID from the ID storage unit 355c (activity A34b), creates a record message from the received profile information, license ID and layer-related information and the generated message ID (activity A34c) passes the created record message to the message transmission unit 353 (activity A34d), and ends the record message creation process.

Operation of Profile Information Acquisition Management Apparatus

The operation of the profile information acquisition management apparatus 302b will be described first, centering on responding to a message received from the profile information acquisition agent apparatus 301b.

Reserve Message Response Process

FIG. 24 is an activity diagram showing the reserve message response process.

The process will be described with reference to FIG. 24. The reserve message response unit 364a, upon receiving a message from the message analysis unit 364c, extracts a message ID from the header of the received message (hereinafter referred to as a reserve message) (activity A35a), passes a search command and the extracted message ID to the position information management unit 367 (activity A35b), receives an entry ID from the position information management unit 367 (activity A35c), and judges whether the received entry ID is an ERROR value (−1) (activity A35d).

If it judges that the received entry ID is an ERROR value (−1), the reserve message response unit 364a creates position information based on the header of the reserve message (activity A35e), passes a registration command and the created position information to the position information management unit 367 (activity A35f), receives an entry ID from the position information management unit 367 (activity A35g), and creates dummy data based on (i) the message size contained in the header of the reserve message and (ii) the layer-related information (activity A35h).

Here, the dummy data is mask data that corresponds to the layer ID information contained in the layer-related information when the mask flag contained in the layer-related information is ON (value “1”), and the dummy data is NULL value (value “0”) when the mask flag is OFF (value “0”). It is supposed here that the size of the dummy data is indicated by the message size.

The reserve message response unit 364a then passes a reserve command, the received entry ID, and the created dummy data to the profile information management unit 368 (activity A35i), receives a record ID from the profile information management unit 368 (activity A35j), passes an update command, the received entry ID and record ID to the position information management unit 367 (activity A35k), receives a message type from the position information management unit 367 (activity A35l), and ends the reserve message response process.

If it judges that the received entry ID is not an ERROR value in the activity A35d, the reserve message, response unit 364a discards the reserve message (activity A35m), and ends the reserve message response process.

Record Message Response Process

FIGS. 25 and 26 are activity diagrams showing the record message response process in Embodiment 3.

The process will be described with reference to FIGS. 25 and 26. The record message response unit 364b, upon receiving a message from the message analysis unit 364c, extracts a reserve ID from the header of the received message (hereinafter referred to as a record message) (activity A36a), passes a search command and the extracted reserve ID to the position information management unit 367 (activity A36b), receives an entry ID from the position information management unit 367 (activity A36c), and judges whether the received entry ID is an ERROR value (−1) (activity A36d).

If it judges that the received entry ID is an ERROR value (−1), the record message response unit 364b creates position information based on the header of the record message (activity A36e), passes a registration command and the created position information to the position information management unit 367 (activity A36f), receives an entry ID from the position information management unit 367 (activity A36g), and extracts profile information from the body of the record message (activity A36h). The record message response unit 364b then passes a record command, the received entry ID, and the extracted profile information to the profile information management unit 368 (activity A36i), receives a record ID from the profile information management unit 368 (activity A36j), passes a fix command and the received entry ID to the position information management unit 367 (activity A36k), receives a message type from the position information management unit 367 (activity A36l), and ends the record message response process.

If it judges that the received entry ID is not an ERROR value (if it is a value other than value “−1”) in the activity A36d, the record message response unit 364b passes an authentication command and the received entry ID to the position information management unit 367 (activity A36m), receives a message type from the position information management unit 367 (activity A36n), and judges whether the received message type is “RECORD_MESSAGE” ( indicating “recorded”) (activity A36o).

If it judges that the received message type is “RECORD_MESSAGE”, the record message response unit 364b discards the received record message (activity A36p), and ends the record message response process.

If it judges that the received message type is not “RECORD_MESSAGE”, which indicates “not recorded”, the record message response unit 364b moves to the activity A36h.

When the record message response unit 364b creates the position information, the field body (reserve ID) of the header field HF307i is stored in the sub-field SF327e, instead of the field body (message ID) of the header field HF307e.

Position Information Management Process

FIGS. 27 and 28 are activity diagrams showing the position information management process in Embodiment 3.

The process will be described with reference to FIGS. 27 and 28. The position information management unit 367, upon receiving a command from the reserve message response unit 364a or the record message response unit 364b, analyzes the received command (activities A371-A375), and executes the following processes respectively for the received commands that are identified by the analysis.

Search Command

If it receives a search command, the position information management unit 367 searches the position information database 327 using as a search key the message ID or reserve ID having been received together with the search command (activity A37a), and judges whether a message ID matching the search key is registered with the position information database 327 (activity A37b).

If it judges that a message ID matching the search key is registered with the position information database 327, the position information management unit 367 acquires an entry ID corresponding to a piece of position information that contains the message ID from the position information database 327 (activity A37c). The position information management unit 367 then returns the acquired entry ID to the sender of the command (activity A37d), and ends the position information management process.

If it judges that a message ID matching the search key is not registered in the activity A37b, the position information management unit 367 returns the ERROR value (−1) to the sender of the command (activity A37e), and ends the position information management process.

Registration Command

If it receives a registration command, the position information management unit 367 generates an entry ID (activity A37f), registers the generated entry ID and the position information, which is received together with the registration command, with the position information database 327 in a manner that they are correlated with each other (activity A37g) returns the generated entry ID to the sender of the command (activity A37h),and ends the position information management process.

Authentication Command

If it receives an authentication command, the position information management unit 367 searches the position information database 327 using as a search key the entry ID having been received together with the authentication command (activity A37i), and judges whether an entry ID matching the search key is registered with the position information database 327 (activity A37j).

If it judges that an entry ID matching the search key is registered with the position information database 327, the position information management unit 367 acquires a message type from a piece of position information that is correlated with the entry ID (activity A37k). The position information management unit 367 then returns the acquired message type to the sender of the command (activity A37l), and ends the position information management process.

If it judges that an entry ID matching the search key is not registered with the position information database 327 in the activity A37j, the position information management unit 367 returns the ERROR value (−1) to the sender of the command (activity A37m), and ends the position information management process.

Update Command

If it receives an update command, the position information management unit 367 searches the position information database 327 using as a search key the entry ID having been received together with the update command (activity A37n), and judges whether an entry ID matching the search key is registered with the position information database 327 (activity A37o).

If it judges that an entry ID matching the search key is registered with the position information database 327, the position information management unit 367 registers the entry ID and the record ID, which is received together with the update command, with the position information database 327 in a manner that they are correlated with each other (activity A37p), returns a value other than the ERROR value to the sender of the command (activity A37q), and ends the position information management process.

If it judges that an entry ID matching the search key is not registered with the position information database 327 in the activity A37o, the position information management unit 367 returns the ERROR value (−1) to the sender of the command (activity A37r), and ends the position information management process.

Fix Command

If it receives a fix command, the position information management unit 367 searches the position information database 327 using as a search key the entry ID having been received together with the fix command (activity A37s), and judges whether an entry ID matching the search key is registered with the position information database 327 (activity A37t).

If it judges that an entry ID matching the search key is registered with the position information database 327, the position information management unit 367 updates the message type contained in a piece of position information correlated with the entry ID from “RESERVE_MESSAGE” to “RECORD_MESSAGE” (activity A37u), returns the updated message type to the sender of the command (activity A37v), and ends the position information management process.

If it judges that an entry ID matching the search key is not registered with the position information database 327 in the activity A37t, the position information management unit 367 returns the ERROR value (−1) to the sender of the command (activity A37w), and ends the position information management process.

If it cannot identify the received command in any of the activities A371-A375), the position information management unit 367 returns the ERROR value (−1) to the sender of the command (activity A37x), and ends the position information management process.

In the activity A37u, the position information management unit 367 may further update a record ID correlated with the entry ID matching the search key to the received record ID.

Profile Information Management Process

FIG. 29 is an activity diagram showing the profile information management process in Embodiment 3.

The process will be described with reference to FIG. 29. The profile information management unit 368, upon receiving a command from the reserve message response unit 364a or the record message response unit 364b, analyzes the received command (activities A381 and A382), and executes the following processes respectively for the received commands that are identified by the analysis.

Reserve Command

If it receives a reserve command, the profile information management unit 368 generates a record ID (activity A38a), registers the generated record ID and the entry ID and dummy data, which are received together with the reserve command, with the profile information database 328 in a manner that they are correlated with each other (activity A38b), returns the generated record ID to the sender of the command (activity A38c), and ends the profile information management process.

Record Command

If it receives a record command, the profile information management unit 368 searches the profile information database 328 using, as a search key, the entry ID having been received together with the record command (activity A38d), and judges whether an entry ID matching the search key is registered with the profile information database 328 (activity A38e).

If it judges that an entry ID matching the search key is registered with the profile information database 328, the profile information management unit 368 replaces the dummy data correlated with the entry ID with the profile information (activity A38f), acquires a record ID correlated with the entry ID (activity A38g), returns the acquired record ID to the sender of the command (activity A38h), and ends the profile information management process.

If it judges that an entry ID matching the search key is not registered with the profile information database 328 in the activity A38e, the profile information management unit 368 returns the ERROR value (−1) to the sender of the command (activity A38i), and ends the profile information management process.

If it cannot identify the received command in any of the activities A381 and A382), the profile information management unit 368 returns the ERROR value (−1) to the sender of the command (activity A38j), and ends the profile information management process.

Operation Example

Now, how messages are transmitted in sequence to the profile information acquisition management apparatus 302b when the system call A is executed by the profile information acquisition agent apparatus 301b.

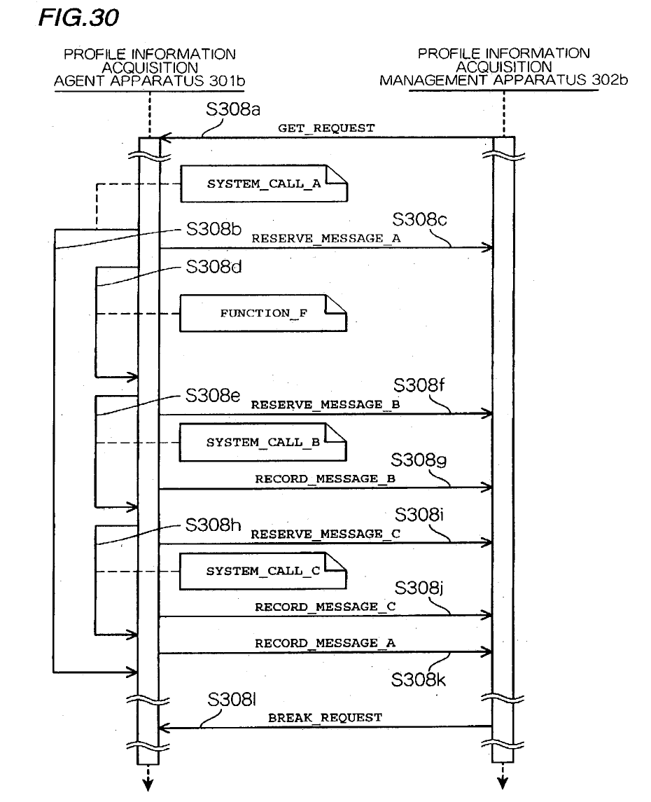

FIG. 30 is a sequence diagram showing a sequence of messages transmitted when the system call A is executed. The sequence of messages will be described with reference to FIG. 30.

The profile information acquisition agent apparatus 301b receives, in advance, an acquisition request (GET_REQUEST) from the profile information acquisition management apparatus 302b and executes the profile information acquisition process (sequence S308a). The second layer software program group execution unit 337 executes the system call A (steps S101-S105) that is contained in the second layer software program group 317 (sequence S308b),

The second layer software program group execution unit 337 executes the storage area reserve process in the step S101 and transmits the reserve message (RESERVE_MESSAGE_A) (sequence S308c), executes the function F in the step S102 (sequence S308d), calls the first, layer software program group execution unit 336 and causes the first layer software program group execution unit 336 to execute the system call B contained in the first layer software program group 316 (sequence S308e).

The first layer software program group execution unit 336, upon being called by the second layer software program group execution unit 337, executes the storage area reserve process and transmits the reserve message (RESERVE_MESSAGE_B) (sequence S308f), executes the profile information recording process before returning the control to the second layer software program group execution unit 337, and transmits the record message (RECORD_MESSAGE_B) (sequence S308g).

The second layer software program group execution unit 337 then calls the first layer software program group execution unit 336 in the step S104 and causes the first layer software program group execution unit 336 to execute the system call C contained in the first layer software program group 316 (sequence S308h).

The first layer software program group execution unit 336, upon being called by the second layer software program group execution unit 337, executes the storage area reserve process and transmits the reserve message (RESERVE_MESSAGE_C) (sequence S308i), executes the profile information recording process before returning the control to the second layer software program group execution unit 337, and transmits the record message (RECORD_MESSAGE_C) (sequence S308j).

The second layer software program group execution unit 337 executes the profile information recording process in the step S105, and transmits the record message (RECORD_MESSAGE_A) (sequence s308k), and ends the system call A.

After this, the profile information acquisition agent apparatus 301b receives a suspend request from the profile information acquisition management apparatus 302b, and suspends the profile information acquisition process (sequence S308l) , and releases the connection after a certain time period passes.

Others for Embodiment 3

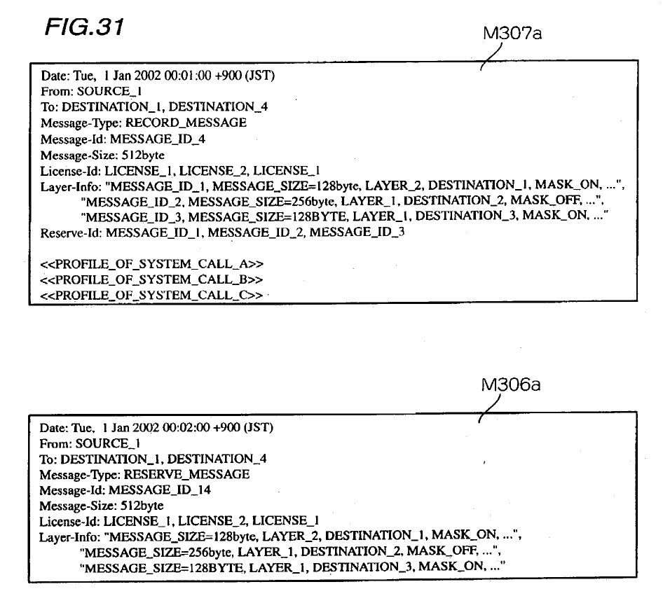

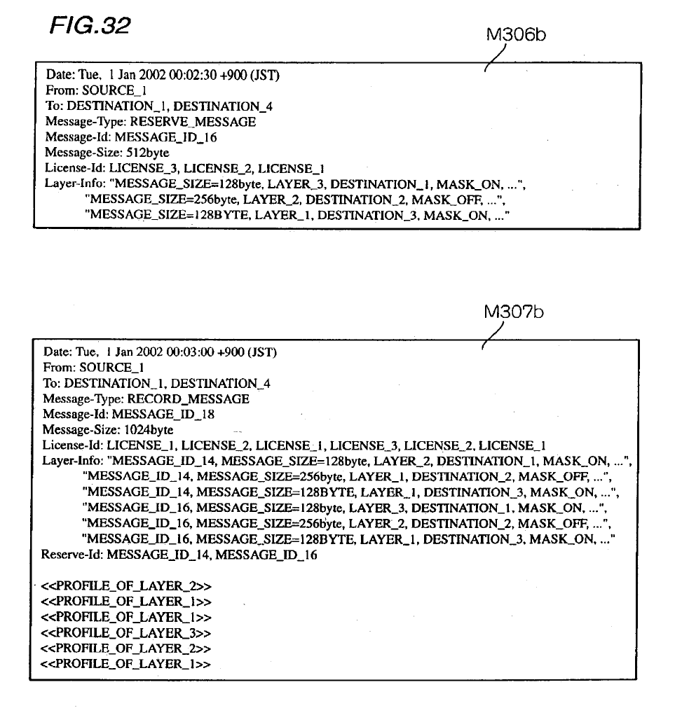

FIGS. 31 and 32 show examples of reserve and record messages.

As shown in, for example, the To field or Reserve-Id field in FIGS. 31 and 32, a plurality of elements in the field body of the header field may be divided by commas (,). Also, as shown in the Layer-Info field, a combined set of a plurality of elements may be indicated by being sandwiched by double quotes (“”). Also, a plurality of elements in the area sandwiched by double quotes may be divided by commas.

As shown in the record message M307a, the profiled information acquisition agent apparatus 301b may transmit, in advance, a plurality of reserve messages created by the reserve message creation unit 355a, then the record message creation unit 355b may create a record message containing a plurality of pieces of profile information, and the message transmission unit 353 may transmit the created record message.

Also, as shown in the reserve messages M306a and M306b, and the record message M307b, the profile information acquisition agent apparatus 301b may transmit, in advance, reserve messages M306a and M306b created by the reserve message creation unit 355a, then the record message creation unit 355b may create a record message containing a plurality of pieces of profile information from the reserve messages M306a and M306b having sizes of a plurality of pieces of profile information, and the message transmission unit 353 may transmit the created record message.

Also, as is the case with the profile information acquisition apparatus 150 described in Embodiment 1, a certain size of profile information may be recorded in the RAM 313, and then a cluster of recorded profile information may be transmitted, or the information may be transmitted in units of blocks.

Also, the layer-related information holding unit for each layer may hold a different transmission destination for each layer.

Also, the profile information maybe stored in a plurality of profile information databases respectively dedicated for the layers, with different addresses assigned thereto, and the DB-related information holding unit 366 may hold the addresses of the databases. For example, the profile information of the first layer will be stored in the first profile information database, and the profile information of the second layer will be stored in the second profile information database. This also applies to the position information database.

Also, the layer-related information held in the layer-related information holding unit of each layer may have an acquisition flag that indicates whether to acquire the profile information or not so that the acquisition of the profile information can be controlled by the acquisition flag.

Also, user ID information may be registered with the profile information acquisition management apparatus 302b in advance, and the profile information acquisition agent apparatus 301b may transmit user ID information that is registered together with a maintenance request, so that the transmission triggers the execution of a sequence of processes including the profile information acquisition process.

Also, the profile information acquisition agent program and the profile information acquisition management program may be executed on the same apparatus.

Also, to use variable-length profile information, the linkage position information described in Embodiment 2 may be extended so as to contain an IP address of an area in which the profile information has been or is to be recorded. The size of the extended linkage position information is obtained by adding up the size of the IP address of the recording destination (that is, 32 bits in case of IPv4, or 128 bits in case of IPv6), the size of the lowest address in the storage area, and the size (constant) of elements to be added such as a separator and an identifier. In this case, as described in Embodiment 2, pieces of profile information are linked with each other via the extended linkage position information.

Also, the extended linkage position information may be represented in the URI format, such as

“profile://[fe80:0000:0000:000008ff:94ff:c71f:4e04]/address/0x01008000h/offset/128 bytes/”.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A profile information acquisition apparatus for acquiring profile information generated in a hardware system under control of a software system having a hierarchical structure composed of layers of software programs including a first program and a second program, the second program calling and executing the first program, the profile information acquisition apparatus comprising:
a storage area allocating unit operable to allocate a hardware system space to a profile information storage area for recording the profile information;
a second-profile-information acquiring unit operable to, when profile information generated by execution of the second program is regarded as second profile information, allocate, during a time period ranging from a start of the execution of the second program to a start of execution of the first program, a space of the profile information storage area to a second storage area for recording the second profile information, acquire the second profile information, and record the acquired second profile information into the second storage area; and
a first-profile-information acquiring unit operable to,
when profile information generated by execution of the first program is regarded as first profile information, acquire, during a time period ranging from the start of the execution of the first program to an end of the execution of the first program, the first profile information, and record the acquired first profile information into a first storage area that follows the second storage area.

2. The profile information acquisition apparatus of claim 1, wherein
when information indicating a lowest address of a storage area in which no profile information is recorded and that is not reserved for recording profile information is regarded as end position information, and
when information indicating a lowest address of a storage area that is reserved for recording profile information is regarded as reserved position information,
the storage area allocating unit allocates hardware system spaces to (i) an end position information storage area for recording the end position information and (ii) a reserved position information storage area for recording the reserved position information by a First-In-Last-Out method, and
when a pointer, which indicates an address in the profile information storage area at which the profile information starts to be recorded, is regarded as a recording start pointer,
the second-profile-information acquiring unit includes:
a reserving unit operable to,
when an address, which is indicated by the recording start pointer when the second storage area is allocated, is regarded as a second start address, and
reserved position information indicating the second start address is regarded as second reserved position information, record the second reserved position information into the reserved position information storage area, and shift the recording start pointer upward from the second start address by a size of the second profile information; and
a recording unit operable to,
when an address, which is indicated by the recording start pointer when the second profile information is recorded, is regarded as a second end address, and
end position information indicating the second end address is regarded as second end position information, record the second end position information into the end position information storage area, read the second reserved position information from the reserved position information storage area, move the recording start pointer to the second start address indicated by the second reserved position information, record the second profile information starting at the second start address toward upper addresses, read the second end position information from the end position information storage area, and move the recording start pointer to the second end address indicated by the second end position information.

3. The profile information acquisition apparatus of claim 2, wherein
the first-profile-information acquiring unit allocates a space of the profile information storage area to the first storage area during a time period ranging from the start of the execution of the first program to the acquisition of the first profile information.

4. The profile information acquisition apparatus of claim 3, wherein
the first profile information and the second profile information have either a same fixed length or different fixed lengths.

5. The profile information acquisition apparatus of claim 4, wherein
the reserving unit, when shifting the recording start pointer upward from the second start address, writes either (i) information indicating a reserved state or (ii) information indicating a layer to which the second program belongs, into the second storage area for the size of the second profile information.

6. A profile information acquisition apparatus for acquiring profile information generated in a hardware system under control of a software system having a hierarchical structure composed of layers of software programs including a first program and a second program, the second program calling and executing the first program, the profile information acquisition apparatus comprising:
a storage area allocating unit operable to,
when information indicating a lowest address of a storage area in which profile information is recorded is regarded as linkage position information, allocate a hardware system space to a linkage position information storage area for recording the linkage position information;
a second-profile-information acquiring unit operable to,
when profile information generated by execution of the second program is regarded as second profile information, and
when linkage position information indicating a lowest address of a storage area in which the second profile information is recorded is regarded as second linkage position information, allocate, during a time period ranging from a start of the execution of the second program to a start of execution of the first program, a space of the linkage position information storage area to a second storage area for recording the second linkage position information, acquire the second profile information, and record the second linkage position information into the second storage area; and
a first-profile-information acquiring unit operable to,
when profile information generated by execution of the first program is regarded as first profile information, and
when linkage position information indicating a lowest address of a storage area in which the first profile information is recorded is regarded as first linkage position information,
acquire, during a time period ranging from the start of the execution of the first program to an end of the execution of the first program, the first profile information, and record the first linkage position information into a first storage area that follows the second storage area.

7. The profile information acquisition apparatus of claim 6, wherein
when information indicating a lowest address of a storage area in which no linkage position information is recorded and that is not reserved for recording linkage position information is regarded as end position information, and
when information indicating a lowest address of a storage area that is reserved for recording linkage position information is regarded as reserved position information,
the storage area allocating unit allocates hardware system spaces to (i) an end position information storage area for recording the end position information and (ii) a reserved position information storage area for recording the reserved position information by a First-In-Last-Out method, and
when a pointer, which indicates an address in the linkage position information storage area at which the linkage position information starts to be recorded, is regarded as a recording start pointer,
the second-profile-information acquiring unit includes:
a reserving unit operable to,
when an address, which is indicated by the recording start pointer when the second storage area is allocated, is regarded as a second start address, and
reserved position information indicating the second start address is regarded as second reserved position information, record the second reserved position information into the reserved position information storage area, and shift the recording start pointer upward from the second start address by a size of the second linkage position information; and
a recording unit operable to,
when an address, which is indicated by the recording start pointer when the second linkage position information is recorded, is regarded as a second end address, and
end position information indicating the second end address is regarded as second end position information, record the second end position information into the end position information storage area, read the second reserved position information from the reserved position information storage area, move the recording start pointer to the second start address indicated by the second reserved position information, record the second linkage position information starting at the second start address toward upper addresses, read the second end position information from the end position information storage area, and move the recording start pointer to the second end address indicated by the second end position information.

8. The profile information acquisition apparatus of claim 7, wherein
the first-profile-information acquiring unit allocates a space of the linkage position information storage area to the first storage area during a time period ranging from the start of the execution of the first program to the acquisition of the first linkage position information.

9. The profile information acquisition apparatus of claim 8, wherein
the first linkage position information and the second linkage position information have either a same fixed length or different fixed lengths.

10. The profile information acquisition apparatus of claim 9, wherein
the reserving unit, when shifting the recording start pointer upward from the second start address, writes either (i) information indicating a reserved state or (ii) information indicating a layer to which the second program belongs, into the second storage area for the size of the second linkage position information.

11. A profile information acquisition apparatus for acquiring profile information generated in a hardware system under control of a software system having a hierarchical structure composed of layers of software programs including a first program and a second program, the second program calling and executing the first program, the profile information acquisition apparatus comprising:
a storage area allocating unit operable to allocate a space of an external storage apparatus, which is connected via a network to the hardware system, to a profile information storage area for recording the profile information;
a second-profile-information acquiring unit operable to,
when profile information generated by execution of the second program is regarded as second profile information, allocate, during a time period ranging from a start of the execution of the second program to a start of execution of the first program, a space of the profile information storage area to a second storage area for recording the second profile information, acquire the second profile information, and record the acquired second profile information into the second storage area; and
a first-profile-information acquiring unit operable to,
when profile information generated by execution of the first program is regarded as first profile information, acquire, during a time period ranging from the start of the execution of the first program to an end of the execution of the first program, the first profile information, and record the acquired first profile information into a first storage area that follows the second storage area.

12. A profile information acquisition apparatus for acquiring profile information generated in a hardware system under control of a software system having a hierarchical structure composed of layers of software programs including a first program and a second program, the second program calling and executing the first program, the profile information acquisition apparatus comprising:
a storage area allocating unit operable to,
when information indicating a lowest address of a storage area in which profile information is recorded is regarded as linkage position information, allocate a space of an external storage apparatus, which is connected via a network to the hardware system, to a linkage position information storage area for recording the linkage position information;
a second-profile-information acquiring unit operable to,
when profile information generated by execution of the second program is regarded as second profile information, and
when linkage position information indicating a lowest address of a storage area in which the second profile information is recorded is regarded as second linkage position information, allocate, during a time period ranging from a start of the execution of the second program to a start of execution of the first program, a space of the linkage position information storage area to a second storage area for recording the second linkage position information, acquire the second profile information, and record the second linkage position information into the second storage area; and
a first-profile-information acquiring unit operable to,
when profile information generated by execution of the first program is regarded as first profile information, and
when linkage position information indicating a lowest address of a storage area in which the first profile information is recorded is regarded as first linkage position information, acquire, during a time period ranging from the start of the execution of the first program to an end of the execution of the first program, the first profile information, and record the first linkage position information into a first storage area that follows the second storage area.

13. A profile information acquisition system composed of a profile information acquisition agent apparatus and a profile information acquisition management apparatus, the profile information acquisition agent apparatus acquiring profile information generated in a hardware system under control of a software system having a hierarchical structure composed of layers of software programs including a first program and a second program, the second program calling and executing the first program, the profile information acquisition management apparatus managing the profile information, the profile information acquisition agent apparatus comprising:
a second-profile-information acquiring unit operable to,
when profile information generated by execution of the second program is regarded as second profile information, instruct, during a time period ranging from a start of the execution of the second program to a start of execution of the first program, to create a second reserve message that indicates that the second profile information is to be transmitted later, acquire the second profile information, and instruct to create a second record message containing the second profile information;
a first-profile-information acquiring unit operable to,
when profile information generated by execution of the first program is regarded as first profile information, acquire, during a time period ranging from the start of the execution of the first program to an end of the execution of the first program, the first profile information, and instruct to create a first record message containing the first profile information;
a message creation unit operable to create a message ID that is identification information created uniquely for each message so as to increase in time series,
create the second reserve message together with a message containing (i) a message ID of the second reserve message and (ii) a size of the second profile information, temporarily store the message ID of the second reserve message as position information,
create the first record message together with a message containing (i) a message ID of the first record message and (ii) the first profile information, and
create the second record message together with a message containing (i) a message ID of the second record message and (ii) the second profile information; and
a message transmission unit operable to transmit messages to the profile information acquisition management apparatus in an order in which the messages are created, the profile information acquisition management apparatus comprising:
a message reception unit operable to receive a message from the profile information acquisition agent apparatus;
a message response unit operable to analyze the received message,
if the received message is found to be the second reserve message, create dummy data in accordance with the second reserve message, instruct to record the dummy data into a profile information database instead of the second reserve message, and instruct to register the message ID contained in the second reserve message with a position information database as position information, and
if the received message is found to be the second record message, instruct to replace the dummy data recorded in the profile information database with the second profile information contained in the second record message;
a position information management unit operable to create an entry ID that is identification information created uniquely for each piece of point information and increases in time series, and register the point information with the position information database in a manner in which the point information is correlated with the entry ID; and
a profile information management unit operable to create a record ID that is identification information created uniquely for each piece of profile information and increases in time series, and record the dummy data into the profile information database in a manner in which the dummy data is correlated with the record ID, and replace the dummy data, which is correlated with the record ID, with the second profile information.

14. A profile information acquisition agent apparatus for acquiring profile information generated in a hardware system under control of a software system having a hierarchical structure composed of layers of software programs including a first program and a second program, the second program calling and executing the first program, the profile information acquisition agent apparatus comprising:
a second-profile-information acquiring unit operable to,
when profile information generated by execution of the second program is regarded as second profile information, instruct, during a time period ranging from a start of the execution of the second program to a start of execution of the first program, to create a second reserve message that indicates that the second profile information is to be transmitted later, acquire the second profile information, and instruct to create a second record message containing the second profile information;
a first-profile-information acquiring unit operable to,
when profile information generated by execution of the first program is regarded as first profile information, acquire, during a time period ranging from the start of the execution of the first program to an end of the execution of the first program, the first profile information, and instruct to create a first record message containing the first profile information;
a message creation unit operable to create a message ID that is identification information created uniquely for each message so as to increase in time series,
create the second reserve message together with a message containing (i) a message ID of the second reserve message and (ii) a size of the second profile information, temporarily store the message ID of the second reserve message as position information,
create the first record message together with a message containing (i) a message ID of the first record message and (ii) the first profile information, and
create the second record message together with a message containing (i) a message ID of the second record message and (ii) the second profile information; and
a message transmission unit operable to transmit messages to a profile information acquisition management apparatus for managing the profile information, in an order in which the messages are created.

15. A profile information acquisition management apparatus for managing profile information generated in a hardware system under control of a software system having a hierarchical structure composed of layers of software programs including a first program and a second program, the second program calling and executing the first program, the profile information acquisition management apparatus comprising:
a message reception unit operable to receive a message from a profile information acquisition agent apparatus that acquires the profile information;
a message response unit operable to,
when profile information generated by execution of the second program is regarded as second profile information,
when a message indicating that the second profile information is to be transmitted later is regarded as a second reserve message, and
when a message containing the second profile information is regarded as a second record message, analyze the received message,
if the received message is found to be the second reserve message, create dummy data in accordance with the second reserve message, instruct to record the dummy data into a profile information database instead of the second reserve message, and instruct to register the message ID contained in the second reserve message with a position information database as position information, and
if the received message is found to be the second record message, instruct to replace the dummy data recorded in the profile information database with the second profile information contained in the second record message;
a position information management unit operable to create an entry ID that is identification information created uniquely for each piece of point information and increases in time series, and register the point information with the position information database in a manner in which the point information is correlated with the entry ID; and
a profile information management unit operable to create a record ID that is identification information created uniquely for each piece of profile information and increases in time series, and record the dummy data into the profile information database in a manner in which the dummy data is correlated with the record ID, and replace the dummy data, which is correlated with the record ID, with the second profile information.

16. A profile information acquisition program for acquiring profile information generated in a hardware system under control of a software system having a hierarchical structure composed of layers of software programs including a first program and a second program, the second program calling and executing the first program, the profile information acquisition program comprising and causing the hardware system and the software system to execute the following steps cooperatively:
a storage area allocating step for allocating a hardware system space to a profile information storage area for recording the profile information;
a second-profile-information acquiring step for, when profile information generated by execution of the second program is regarded as second profile information, allocating, during a time period ranging from a start of the execution of the second program to a start of execution of the first program, a space of the profile information storage area to a second storage area for recording the second profile information, acquiring the second profile information, and recording the acquired second profile information into the second storage area; and
a first-profile-information acquiring step for, when profile information generated by execution of the first program is regarded as first profile information, acquiring, during a time period ranging from the start of the execution of the first program to an end of the execution of the first program, the first profile information, and recording the acquired first profile information into a first storage area that follows the second storage area.

17. The profile information acquisition program of claim 16, wherein
when information indicating a lowest address of a storage area in which no profile information is recorded and that is not reserved for recording profile information is regarded as end position information, and
when information indicating a lowest address of a storage area that is reserved for recording profile information is regarded as reserved position information,
the storage area allocating step allocates hardware system spaces to (i) an end position information storage area for recording the end position information and (ii) a reserved position information storage area for recording the reserved position information by a First-In-Last-Out method, and
when a pointer, which indicates an address in the profile information storage area at which the profile information starts to be recorded, is regarded as a recording start pointer,
the second-profile-information acquiring step includes:
a reserving substep for,
when an address, which is indicated by the recording start pointer when the second storage area is allocated, is regarded as a second start address, and
reserved position information indicating the second start address is regarded as second reserved position information, recording the second reserved position information into the reserved position information storage area, and shifting the recording start pointer upward from the second start address by a size of the second profile information; and
a recording substep for,
when an address, which is indicated by the recording start pointer when the second profile information is recorded, is regarded as a second end address, and
end position information indicating the second end address is regarded as second end position information, recording the second end position information into the end position information storage area, reading the second reserved position information from the reserved position information storage area, moving the recording start pointer to the second start address indicated by the second reserved position information, recording the second profile information starting at the second start address toward upper addresses, reading the second end position information from the end position information storage area, and moving the recording start pointer to the second end address indicated by the second end position information.

18. The profile information acquisition program of claim 17, wherein
the first-profile-information acquiring step allocates a space of the profile information storage area to the first storage area during a time period ranging from the start of the execution of the first program to the acquisition of the first profile information.

19. The profile information acquisition program of claim 18, wherein
the first profile information and the second profile information have either a same fixed length or different fixed lengths.

20. The profile information acquisition program of claim 19, wherein
the reserving substep, when shifting the recording start pointer upward from the second start address, writes either (i) information indicating a reserved state or (ii) information indicating a layer to which the second program belongs, into the second storage area for the size of the second profile information.

21. A profile information acquisition program for acquiring profile information generated in a hardware system under control of a software system having a hierarchical structure composed of layers of software programs including a first program and a second program, the second program calling and executing the first program, the profile information acquisition program comprising and causing the hardware system and the software system to execute the following steps cooperatively:
a storage area allocating step for,
when information indicating a lowest address of a storage area in which profile information is recorded is regarded as linkage position information, allocating a hardware system space to a linkage position information storage area for recording the linkage position information;
a second-profile-information acquiring step for,
when profile information generated by execution of the second program is regarded as second profile information, and
when linkage position information indicating a lowest address of a storage area in which the second profile information is recorded is regarded as second linkage position information, allocating, during a time period ranging from a start of the execution of the second program to a start of execution of the first program, a space of the linkage position information storage area to a second storage area for recording the second linkage position information, acquiring the second profile information, and recording the second linkage position information into the second storage area; and
a first-profile-information acquiring step for,
when profile information generated by execution of the first program is regarded as first profile information, and
when linkage position information indicating a lowest address of a storage area in which the first profile information is recorded is regarded as first linkage position information, acquiring, during a time period ranging from the start of the execution of the first program to an end of the execution of the first program, the first profile information, and recording the first linkage position information into a first storage area that follows the second storage area.

22. The profile information acquisition program of claim 21, wherein
when information indicating a lowest address of a storage area in which no linkage position information is recorded and that is not reserved for recording linkage position information is regarded as end position information, and
when information indicating a lowest address of a storage area that is reserved for recording linkage position information is regarded as reserved position information,
the storage area allocating step allocates hardware system spaces to (i) an end position information storage area for recording the end position information and (ii) a reserved position information storage area for recording the reserved position information by a First-In-Last-Out method, and
when a pointer, which indicates an address in the linkage position information storage area at which the linkage position information starts to be recorded, is regarded as a recording start pointer,
the second-profile-information acquiring step includes:
a reserving substep for,
when an address, which is indicated by the recording start pointer when the second storage area is allocated, is regarded as a second start address, and
reserved position information indicating the second start address is regarded as second reserved position information, recording the second reserved position information into the reserved position information storage area, and shifting the recording start pointer upward from the second start address by a size of the second linkage position information; and
a recording substep for,
when an address, which is indicated by the recording start pointer when the second linkage position information is recorded, is regarded as a second end address, and
end position information indicating the second end address is regarded as second end position information, recording the second end position information into the end position information storage area, reading the second reserved position information from the reserved position information storage area, moving the recording start pointer to the second start address indicated by the second reserved position information, recording the second linkage position information starting at the second start address toward upper addresses, reading the second end position information from the end position information storage area, and moving the recording start pointer to the second end address indicated by the second end position information.

23. The profile information acquisition program of claim 22, wherein
the first-profile-information acquiring step allocates a space of the linkage position information storage area to the first storage area during a time period ranging from the start of the execution of the first program to the acquisition of the first linkage position information.

24. The profile information acquisition program of claim 23, wherein
the first linkage position information and the second linkage position information have either a same fixed length or different fixed lengths.

25. The profile information acquisition program of claim 24, wherein
the reserving substep, when shifting the recording start pointer upward from the second start address, writes either (i) information indicating a reserved state or (ii) information indicating a layer to which the second program belongs, into the second storage area for the size of the second linkage position information.

26. A profile information acquisition program for acquiring profile information generated in a hardware system under control of a software system having a hierarchical structure composed of layers of software programs including a first program and a second program, the second program calling and executing the first program, the profile information acquisition program comprising and causing the hardware system and the software system to execute the following steps cooperatively:
a storage area allocating step for allocating a space of an external storage program, which is connected via a network to the hardware system, to a profile information storage area for recording the profile information;
a second-profile-information acquiring step for,
when profile information generated by execution of the second program is regarded as second profile information, allocating, during a time period ranging from a start of the execution of the second program to a start of execution of the first program, a space of the profile information storage area to a second storage area for recording the second profile information, acquiring the second profile information, and recording the acquired second profile information into the second storage area; and
a first-profile-information acquiring step for,
when profile information generated by execution of the first program is regarded as first profile information, acquiring, during a time period ranging from the start of the execution of the first program to an end of the execution of the first program, the first profile information, and recording the acquired first profile information into a first storage area that follows the second storage area.

27. A profile information acquisition program for acquiring profile information generated in a hardware system under control of a software system having a hierarchical structure composed of layers of software programs including a first program and a second program, the second program calling and executing the first program, the profile information acquisition program comprising and causing the hardware system and the software system to execute the following steps cooperatively:
a storage area allocating step for,
when information indicating a lowest address of a storage area in which profile information is recorded is regarded as linkage position information, allocating a space of an external storage program, which is connected via a network to the hardware system, to a linkage position information storage area for recording the linkage position information;
a second-profile-information acquiring step for,
when profile information generated by execution of the second program is regarded as second profile information, and
when linkage position information indicating a lowest address of a storage area in which the second profile information is recorded is regarded as second linkage position information, allocating, during a time period ranging from a start of the execution of the second program to a start of execution of the first program, a space of the linkage position information storage area to a second storage area for recording the second linkage position information, acquiring the second profile information, and recording the second linkage position information into the second storage area; and
a first-profile-information acquiring step for,
when profile information generated by execution of the first program is regarded as first profile information, and
when linkage position information indicating a lowest address of a storage area in which the first profile information is recorded is regarded as first linkage position information, acquiring, during a time period ranging from the start of the execution of the first program to an end of the execution of the first program, the first profile information, and recording the first linkage position information into a first storage area that follows the second storage area.

28. A profile information acquisition system program composed of a profile information acquisition agent program and a profile information acquisition management program, the profile information acquisition agent program acquiring profile information generated in a hardware system under control of a software system having a hierarchical structure composed of layers of software programs including a first program and a second program, the second program calling and executing the first program, the profile information acquisition management program managing the profile information, the profile information acquisition agent program comprising:
a second-profile-information acquiring step for,
when profile information generated by execution of the second program is regarded as second profile information, instructing, during a time period ranging from a start of the execution of the second program to a start of execution of the first program, to create a second reserve message that indicates that the second profile information is to be transmitted later, acquiring the second profile information, and instructing to create a second record message containing the second profile information;
a first-profile-information acquiring step for, when profile information generated by execution of the first program is regarded as first profile information, acquiring, during a time period ranging from the start of the execution of the first program to an end of the execution of the first program, the first profile information, and instructing to create a first record message containing the first profile information;
a message creation step for creating a message ID that is identification information created uniquely for each message so as to increase in time series,
creating the second reserve message together with a message containing (i) a message ID of the second reserve message and (ii) a size of the second profile information, temporarily store the message ID of the second reserve message as position information,
creating the first record message together with a message containing (i) a message ID of the first record message and (ii) the first profile information, and
creating the second record message together with a message containing (i) a message ID of the second record message and (ii) the second profile information; and
a message transmission step for transmitting messages to the profile information acquisition management program in an order in which the messages are created, the profile information acquisition management program comprising:
a message reception step for receiving a message from the profile information acquisition agent program;
a message response step for analyzing the received message,
if the received message is found to be the second reserve message, creating dummy data in accordance with the second reserve message, instructing to record the dummy data into a profile information database instead of the second reserve message, and instructing to register the message ID contained in the second reserve message with a position information database as position information, and
if the received message is found to be the second record message, instructing to replace the dummy data recorded in the profile information database with the second profile information contained in the second record message;
a position information management step for creating an entry ID that is identification information created uniquely for each piece of point information and increases in time series, and registering the point information with the position information database in a manner in which the point information is correlated with the entry ID; and
a profile information management step for creating a record ID that is identification information created uniquely for each piece of profile information and increases in time series, and recording the dummy data into the profile information database in a manner in which the dummy data is correlated with the record ID, and replacing the dummy data, which is correlated with the record ID, with the second profile information.

29. A profile information acquisition agent program for acquiring profile information generated in a hardware system under control of a software system having a hierarchical structure composed of layers of software programs including a first program and a second program, the second program calling and executing the first program, the profile information acquisition agent program comprising:
a second-profile-information acquiring step for,
when profile information generated by execution of the second program is regarded as second profile information, instructing, during a time period ranging from a start of the execution of the second program to a start of execution of the first program, to create a second reserve message that indicates that the second profile information is to be transmitted later, acquiring the second profile information, and instructing to create a second record message containing the second profile information;
a first-profile-information acquiring step for, when profile information generated by execution of the first program is regarded as first profile information, acquiring, during a time period ranging from the start of the execution of the first program to an end of the execution of the first program, the first profile information, and instructing to create a first record message containing the first profile information;
a message creation step for creating a message ID that is identification information created uniquely for each message so as to increase in time series,
creating the second reserve message together with a message containing (i) a message ID of the second reserve message and (ii) a size of the second profile information, temporarily store the message ID of the second reserve message as position information,
creating the first record message together with a message containing (i) a message ID of the first record message and (ii) the first profile information, and
creating the second record message together with a message containing (i) a message ID of the second record message and (ii) the second profile information; and
a message transmission step for transmitting messages to a profile information acquisition management program for managing the profile information, in an order in which the messages are created.

30. A profile information acquisition management program for managing profile information generated in a hardware system under control of a software system having a hierarchical structure composed of layers of software programs including a first program and a second program, the second program calling and executing the first program, the profile information acquisition management program comprising:
a message reception step for receiving a message from a profile information acquisition agent program that acquires the profile information;
a message response step for,
when profile information generated by execution of the second program is regarded as second profile information,
when a message indicating that the second profile information is to be transmitted later is regarded as a second reserve message, and
when a message containing the second profile information is regarded as a second record message, analyzing the received message,
if the received message is found to be the second reserve message, creating dummy data in accordance with the second reserve message, instructing to record the dummy data into a profile information database instead of the second reserve message, and instructing to register the message ID contained in the second reserve message with a position information database as position information, and
if the received message is found to be the second record message, instructing to replace the dummy data recorded in the profile information database with the second profile information contained in the second record message;
a position information management step for creating an entry ID that is identification information created uniquely for each piece of point information and increases in time series, and registering the point information with the position information database in a manner in which the point information is correlated with the entry ID; and
a profile information management step for creating a record ID that is identification information, created uniquely for each piece of profile information and increases in time series, and recording the dummy data into the profile information database in a manner in which the dummy data is correlated with the record ID, and replacing the dummy data, which is correlated with the record ID, with the second profile information.
